(19) United States
(12) Patent Application Publication
(10) Pub. No.: US 2025/0119778 A1
(43) Pub. Date: Apr. 10, 2025

(54) CHANNEL STATE INFORMATION FOR SPATIAL DOMAIN ADAPTATION

(71) Applicant: QUALCOMM Incorporated, San Diego, CA (US)

(72) Inventor: Hung Dinh LY, San Diego, CA (US)

(21) Appl. No.: 18/482,573

(22) Filed: Oct. 6, 2023

(51) Int. Cl. H04W 24/10; H04L 5/00; H04W 72/541; H04W 72/542

(52) U.S. Cl. CPC H04W 24/10; H04L 5/0048; H04W 72/541; H04W 72/542

(57) ABSTRACT

Various aspects of the present disclosure generally relate to wireless communication. In some aspects, a user equipment (UE) may receive a channel state information (CSI) report configuration that indicates a CSI reference signal (CSI-RS) resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group. The UE may transmit a CSI report including CSI that is in accordance with the sub-configuration. Numerous other aspects are described.

### FIELD OF THE DISCLOSURE

Aspects of the present disclosure generally relate to wireless communication and to techniques and apparatuses for channel state information (CSI) for spatial domain adaptation (e.g., for multiple transmission reception point (mTRP) scenarios).

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

In some aspects, an apparatus for wireless communication includes one or more memories; and one or more processors coupled to the one or more memories, the one or more processors individually or collectively configured to: receive a channel state information (CSI) report configuration that indicates a CSI reference signal (CSI-RS) resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group; and transmit a CSI report that includes CSI that is in accordance with the sub-configuration.

In some aspects, an apparatus for wireless communication includes one or more memories; and one or more processors coupled to the one or more memories, the one or more processors individually or collectively configured to: transmit a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group; and receive a CSI report that includes CSI that is in accordance with the sub-configuration.

In some aspects, a method of wireless communication performed by a user equipment (UE) includes receiving a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group; and transmitting a CSI report that includes CSI that is in accordance with the sub-configuration.

In some aspects, a method of wireless communication performed by a network node includes transmitting a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group; and receiving a CSI report that includes CSI that is in accordance with the sub-configuration.

In some aspects, a non-transitory computer-readable medium storing a set of instructions for wireless communication includes one or more instructions that, when executed by one or more processors of a UE, cause the UE to: receive a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group; and transmit a CSI report that includes CSI that is in accordance with the sub-configuration.

In some aspects, a non-transitory computer-readable medium storing a set of instructions for wireless communication includes one or more instructions that, when executed by one or more processors of a network node, cause the network node to: transmit a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group; and receive a CSI report that includes CSI that is in accordance with the sub-configuration.

In some aspects, an apparatus for wireless communication includes means for receiving a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group; and means for transmitting a CSI report that includes CSI that is in accordance with the sub-configuration.

In some aspects, an apparatus for wireless communication includes means for transmitting a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group; and means for receiving a CSI report that includes CSI that is in accordance with the sub-configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 illustrates an example logical architecture of a distributed radio access network, in accordance with the present disclosure.

FIG. 5 is a diagram illustrating an example of multiple transmission reception point (TRP) communication, in accordance with the present disclosure.

FIG. 6 is a diagram illustrating an example of spatial domain adaptation, in accordance with the present disclosure.

FIGS. 7A-7B are diagrams illustrating examples of channel state information reference signal (CSI-RS) beam management procedures, in accordance with the present disclosure.

FIG. 8 is a diagram illustrating an example of CSI-RS ports, in accordance with the present disclosure.

FIG. 9 is a diagram illustrating an example of adaptation in the spatial domain, in accordance with the present disclosure.

FIG. 10 is a diagram illustrating an example of non-coherent joint transmission for multiple TRPs, in accordance with the present disclosure.

FIG. 11 is a diagram of an example associated with channel state information for spatial domain adaptation, in accordance with the present disclosure.

FIG. 12 is a diagram illustrating an example process performed, for example, at a UE or an apparatus of a UE, in accordance with the present disclosure.

FIG. 13 is a diagram illustrating an example process performed, for example, at a network node or an apparatus of a network node, in accordance with the present disclosure.

FIG. 14 is a diagram of an example apparatus for wireless communication, in accordance with the present disclosure.

FIG. 15 is a diagram of an example apparatus for wireless communication, in accordance with the present disclosure.

### DETAILED DESCRIPTION

A user equipment (UE) may measure channel state information (CSI) reference signals (CSI-RSs) and provide CSI feedback to a network node for beam management and communication scheduling. The CSI-RSs may be part of a CSI-RS resource that is associated with a two-dimensional antenna array. A network node may transmit a CSI-RS signal associated with a full antenna array, and the UE may generate multiple CSIs for different antenna subarrays using the same received CSI-RS signal. The multiple CSIs for different antenna subarrays may be referred to as CSI for spatial domain adaptation. Each antenna subarray may be associated with a subset of CSI-RS ports (e.g., from a set of CSI-RS ports associated with the full antenna array) or a subset of antenna elements (e.g., from a set of antenna elements associated with the full antenna array). The different subarrays are used by the UE for the purpose of CSI calculation. The network node may use the CSI to determine one or more CSI-RS ports or one or more antenna elements to be deactivated for improved power savings. For example, the network node may configure the UE to report CSI for different spatial domain adaptation patterns using sub-configurations of a CSI report setting (e.g., where the sub-configurations are associated with respective spatial domain adaptation patterns of the network node). For a first type of spatial domain adaptation, the network node may adapt (or deactivate) one or more CSI-RS ports for improved power savings (e.g., for logical antenna port adaptation). For a second type of spatial domain adaptation, the network node may adapt (or deactivate) one or more antenna elements for improved power savings (e.g., for physical antenna element adaptation).

In some examples, a network (e.g., one or more network nodes) may support multiple transmission reception point (TRP) operations. Multiple TRP (multi-TRP) operations may include multiple TRPs communicating with the same UE to improve reliability and/or to increase throughput. The UE may be configured with a CSI framework that enables the UE to report CSI for different multi-TRP scenarios. For example, when a network node configures the UE for multi-TRP operation, the network node may configure the UE with a CSI-RS resource set that the UE may use for channel measurements. A CSI-RS resource for channel measurement may be referred to as a channel measurement resource (CMR). In such examples, the CSI-RS resource set may include a quantity of resources, Kₛ, which may be divided into separate resource groups for each TRP. The resources Kₛ may be referred to as a resource set or a CMR set. The UE 120 may be configured to measure and/or report CSI for a given CMR (e.g., for single TRP) and/or for a pair of CMRs (e.g., for multi-TRP). As used herein, a “resource group” may include one or more CSI-RS resources for channel measurements. A resource group may include CSI-RSs for a given TRP. A resource group may also be referred to as a “CMR group.”

However, for multi-TRP CSI, each TRP (e.g., each CMR) may be associated with the same CSI-RS port configuration. In other words, each TRP may use the same CSI-RS ports and/or the same antenna configuration to configure the UE to report CSI for transmissions from multiple TRPs. Because the multiple TRPs may use the same CSI-RS port configuration for multi-TRP CSI, the network node may be unable to configure CSI reporting for spatial domain adaptation in multi-TRP scenarios (e.g., because the network node may be restricted to configuring each TRP with the same CSI-RS port configuration and therefore may be unable to perform spatial domain adaptation for only one of the TRPs). Therefore, the network node may be unable to obtain CSI for spatial domain adaptation in a multi-TRP scenario. This may result in increased network power usage in multi-TRP scenarios because the network node may not employ spatial domain adaptation (e.g., because the network node may not receive CSI for spatial domain adaptation indicating which antenna elements and/or which CSI-RS ports are suitable for deactivation).

Alternatively, if the network node is utilizing spatial domain adaptation for one or more TRPs, the network node may be unable to perform multi-TRP operations. For example, if the network node configures a CSI report setting for a given TRP to enable the network node to obtain CSI for spatial domain adaptation, then the network node may be unable to configure CSI report setting for the given TRP to enable the network node to obtain multi-TRP CSI. In other words, the network node may be unable to configure both a CSI framework for spatial domain adaptation and a CSI framework for multi-TRP operations. This may decrease flexibility for operations via the network node because the network node may choose to support either spatial domain adaptation for improved power savings or multi-TRP operations.

Aspects of the present disclosure relate generally to CSI for spatial domain adaptation (e.g., in multi-TRP scenarios). Some aspects more specifically relate to one or more network nodes transmitting, and a UE receiving, a CSI report configuration that indicates a CSI-RS resource set for channel measurement that includes a sub-configuration to support spatial domain adaptation and multi-TRP CSI estimation and reporting. For example, the CSI-RS resource set may be associated with a first resource group and a second resource group. The sub-configuration may indicate first configuration information for the first resource group and second configuration information for the second resource group. Additionally, or alternatively, the sub-configuration may indicate third configuration information associated with one or more pairs of resources from the first resource group and the second resource group. The UE 120 may transmit, and the network node 110 may receive, a CSI report that includes CSI that is in accordance with the sub-configuration.

As a result, the network node may receive CSI for different spatial domain adaptation parameters in multi-TRP scenarios. For example, the CSI report may indicate CSI for different spatial domain adaptation patterns for one or more TRPs in a multi-TRP scenario (e.g., where one or more CMRs in a CMR pair use configuration information that is different than the configuration information for the CSI-RS resource set). For example, the sub-configuration may configure the UE to perform CSI calculation for spatial domain adaptation using a multi-TRP CSI framework. As a result, the network node may be able to use spatial domain adaptation in multi-TRP scenarios. This may improve power savings for the network node (e.g., by enabling one or more TRPs to deactivate CSI-RS port(s) or antenna element(s)) while also improving throughput and/or reliability for communications with the UE 120 via multi-TRP operations.

In some aspects, the first configuration information and/or the second configuration information may indicate one or more parameters that are different than a corresponding parameter for the CSI-RS resource set. For example, the first configuration information and/or the second configuration information may indicate a CSI-RS port configuration that is common for resources in the first resource group and the second resource group. As a result, a different CSI-RS port configuration may be indicated for the sub-configuration (e.g., that is different than the CSI-RS port configuration associated with the CSI-RS resource set), thereby enabling the UE to report CSI for logical port spatial domain adaptation (referred to herein as Type 1 spatial domain adaptation). As another example, the first configuration information may indicate a first CSI-RS port configuration for the first resource group and the second configuration may indicate a second CSI-RS port configuration for the second resource group. This may enable the UE to calculate and/or report CSI for resource pairs that are associated with different CSI-RS port configurations (e.g., may enable CSI to be calculated when different TRPs use different spatial domain adaptation parameters).

In some aspects, the first configuration information may indicate a first list of one or more CSI-RS resources to be associated with the first resource group and the second configuration information may indicate a second list of one or more CSI-RS resources to be associated with the second resource group. For example, the sub-configuration may define different CSI-RS resources for the first group and the second group. In some aspects, the first configuration information may indicate a first list of one or more CSI-RS resources (e.g., from CSI-RS resource(s) included in the first resource group) and the second configuration information may indicate a second list of one or more CSI-RS resources (e.g., from CSI-RS resource(s) included in the second resource group). For example, the CSI report setting may define the first resource group and the second resource group and the sub-configuration may define different CSI-RS resources for the first group and the second group for the sub-configuration. This may enable different CSI-RS resources to be associated with the first group and the second group for the sub-configuration, thereby enabling CSI to be obtained for antenna-element-based spatial domain adaptation (e.g., referred to herein as Type 2 spatial domain adaptation). For example, each CSI-RS resource may be associated with the same CSI-RS port configuration, but the sub-configuration may enable the network node to configure the UE to calculate and/or report CSI for different antenna element adaptations for one or more TRPs in a multi-TRP scenario.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

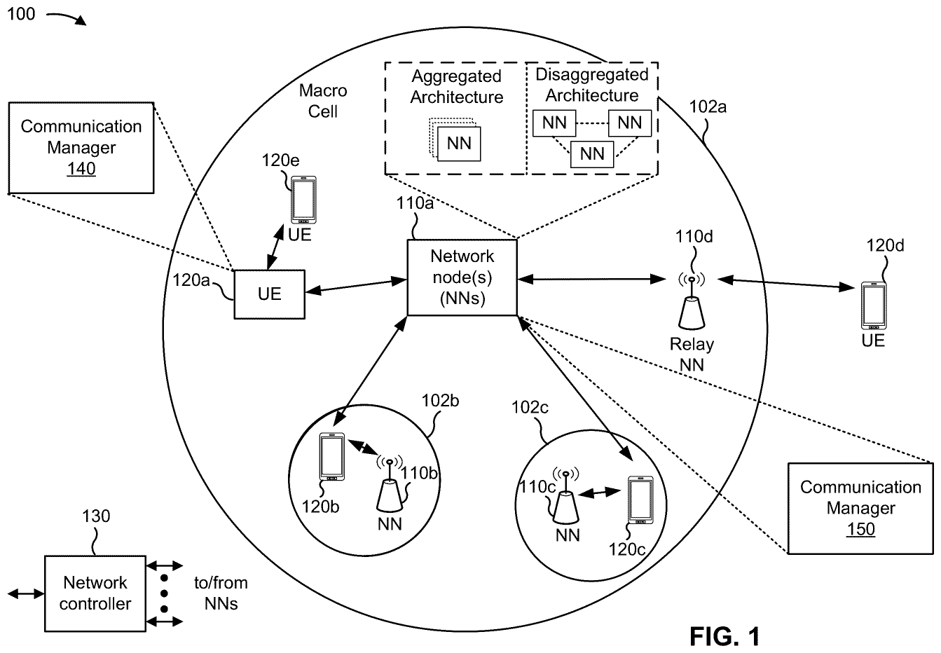

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group; and transmit a CSI report that includes CSI that is in accordance with the sub-configuration. Additionally, or alternatively, the communication manager 140 may perform one or more other operations described herein.

In some aspects, the network node 110 may include a communication manager 150. As described in more detail elsewhere herein, the communication manager 150 may transmit a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group; and receive a CSI report that includes CSI that is in accordance with the sub-configuration. Additionally, or alternatively, the communication manager 150 may perform one or more other operations described herein.

As indicated above, FIG. 1 is provided as an example. Other examples may differ from what is described with regard to FIG. 1.

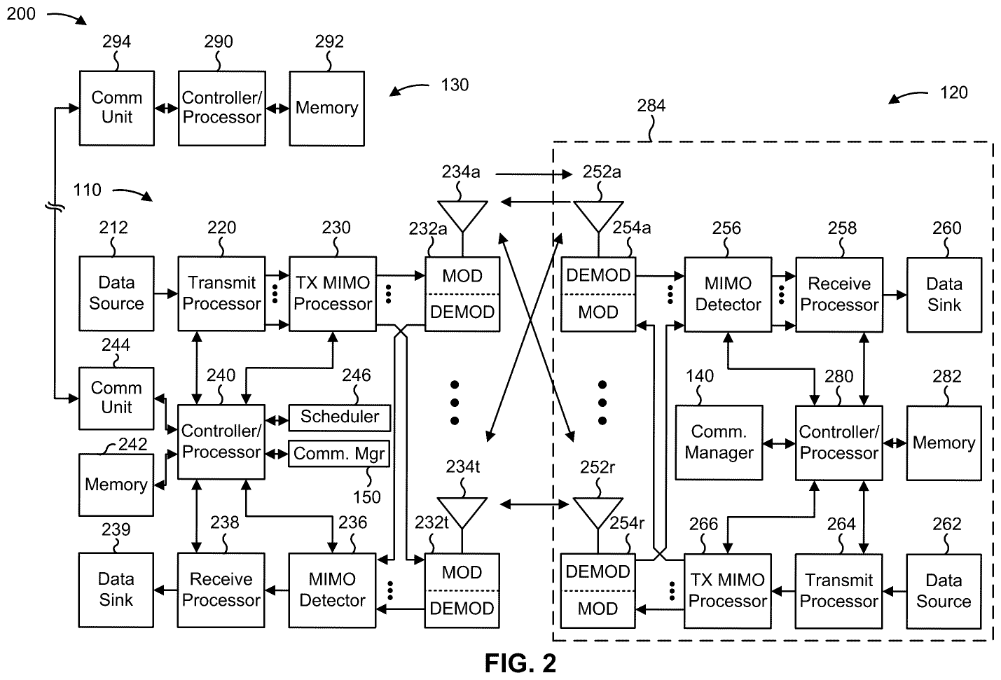

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

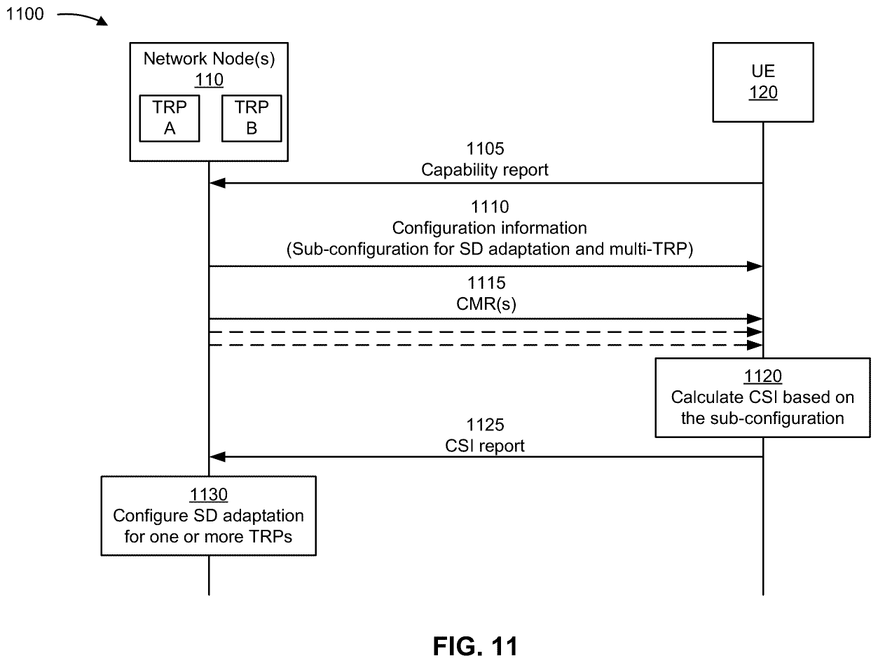

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 11-15).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 11-15).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

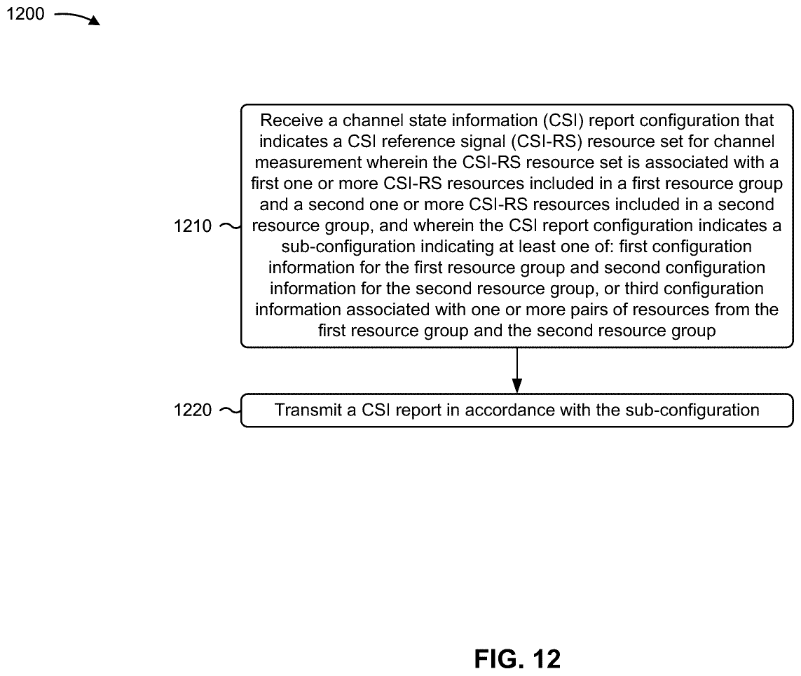

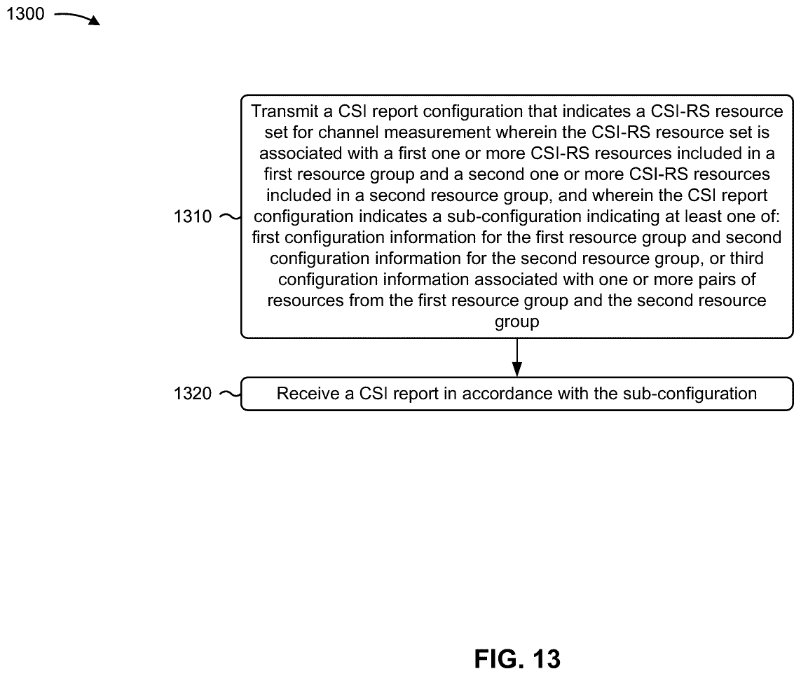

The controller/processor 240 of the network node 110, the controller/processor 280 of the UE 120, or any other component(s) of FIG. 2 may perform one or more techniques associated with CSI for spatial domain adaptation, as described in more detail elsewhere herein. For example, the controller/processor 240 of the network node 110, the controller/processor 280 of the UE 120, or any other component(s) (or combinations of components) of FIG. 2 may perform or direct operations of, for example, process 1200 of FIG. 12, process 1300 of FIG. 13, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE 120 includes means for receiving a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group; and/or means for transmitting a CSI report that includes CSI that is in accordance with the sub-configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group; and/or means for receiving a CSI report that includes CSI that is in accordance with the sub-configuration. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

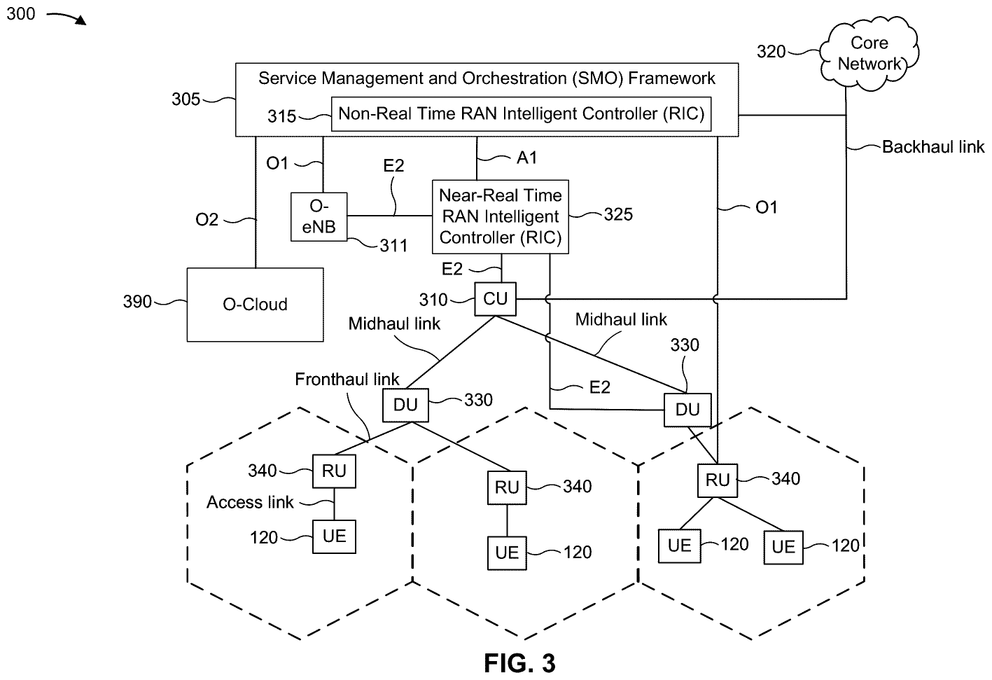

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

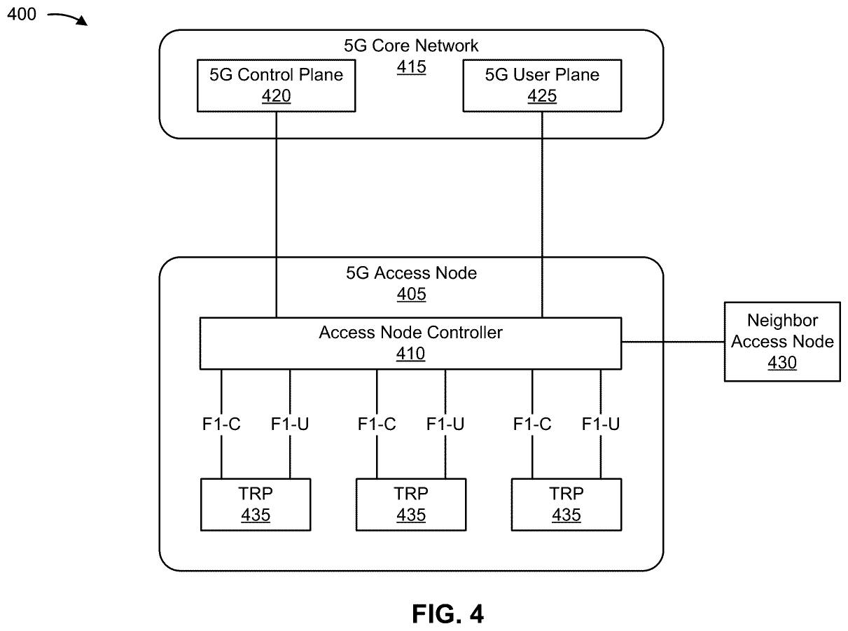

FIG. 4 illustrates an example logical architecture of a distributed RAN 400, in accordance with the present disclosure.

A 5G access node 405 may include an access node controller 410. The access node controller 410 may be a central unit (CU) of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may include a distributed unit (DU) and/or a radio unit (RU) of the distributed RAN 400. In some aspects, a TRP 435 may correspond to a network node 110 described above in connection with FIG. 1. For example, different TRPs 435 may be included in different network nodes 110. Additionally, or alternatively, multiple TRPs 435 may be included in a single network node 110. In some aspects, a network node 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400, referred to elsewhere herein as a functional split. For example, a packet data convergence protocol (PDCP) layer, a radio link control (RLC) layer, and/or a medium access control (MAC) layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

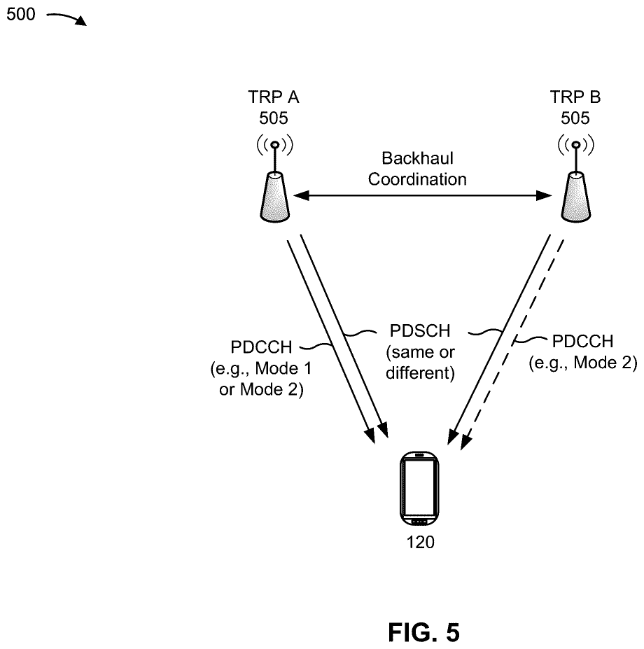

FIG. 5 is a diagram illustrating an example 500 of multi-TRP communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same network node 110 (e.g., when the TRPs 505 are different antenna arrays or panels of the same network node 110), and may have a larger delay and/or lower capacity (as compared to co-location) when the TRPs 505 are located at different network nodes 110. The different TRPs 505 may communicate with the UE 120 using different QCL relationships (e.g., different TCI states), different demodulation reference signal (DMRS) ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

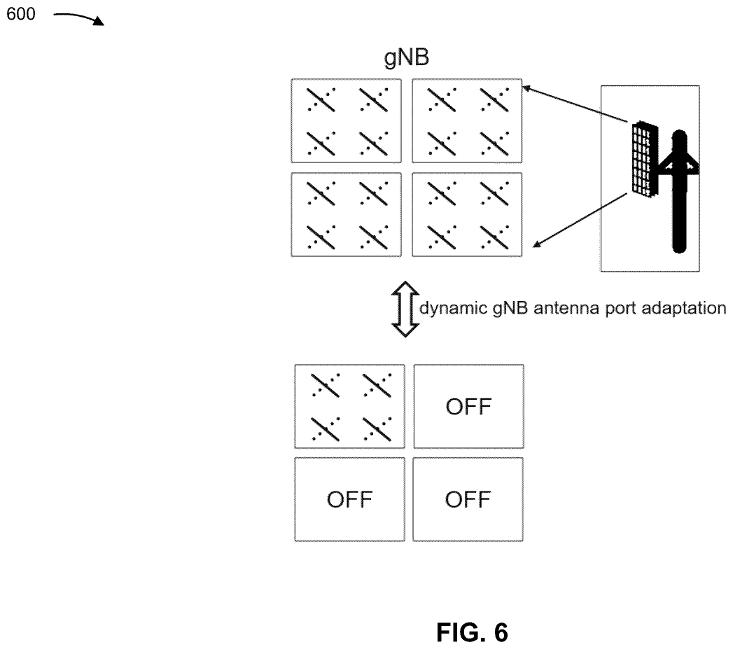

FIG. 6 is a diagram illustrating an example 600 of spatial domain adaptation, in accordance with the present disclosure.

Massive MIMO provides high spectral efficiency and extended coverage by communicating using a large number of antennas. For downlink transmission, a network node supporting massive MIMO may be equipped with a large number of transceiver chains (e.g., 64 transceiver chains in FR1 are typically deployed in commercial 5G networks, especially at carrier frequencies of 3.5 GHz and/or higher). Each transceiver chain may be connected to one or more power amplifiers. The power amplifiers may consume a significant portion of the network node's energy (e.g., 70%-80% of network node power). To control or reduce network power consumption, a cell (e.g., a network node) can turn on or off one or more power amplifiers (such as depending on the time and frequency resource utilization in the cell). Equivalently, a network node can turn on or off one or more transceiver chains.

Spatial domain adaptation at a network node may include deactivating one or more antenna panels (spatial elements, ports) such that fewer antenna panels or antenna elements are active. Example 600 shows four antenna panels of a network node (e.g., gNB). The network node may deactivate three of the four antenna panels. The three deactivated panels are shown as OFF. Indications related to spatial domain adaptation may help UEs to adapt a CSI-RS configuration to dynamic or semi-persistent activation or deactivation of CSI-RS, or to reconfigure the CSI-RS configuration with respect to an adapted number of spatial elements or ports. A network entity may dynamically select CSI report configurations via a selected triggering state (e.g., CSI-AperiodicTriggerStateList, CSI-SemiPersistentOnPUSCH-TriggerStateList), such as by a MAC control element (MAC-CE) or downlink control information (DCI).

Power control offsets may be used to adapt a transmit power for CSI-RSs. In a first step, CSI feedback may be provided for adaptation of power offset values. In a second step, a physical downlink shared channel (PDSCH) may be transmitted with a suitable power offset configuration.

As indicated above, FIG. 6 is provided as an example. Other examples may differ from what is described with regard to FIG. 6.

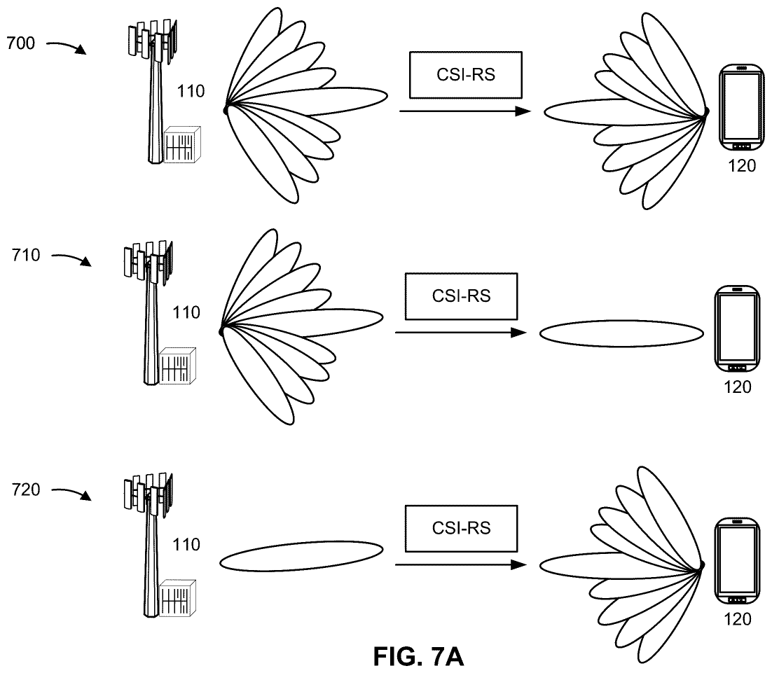

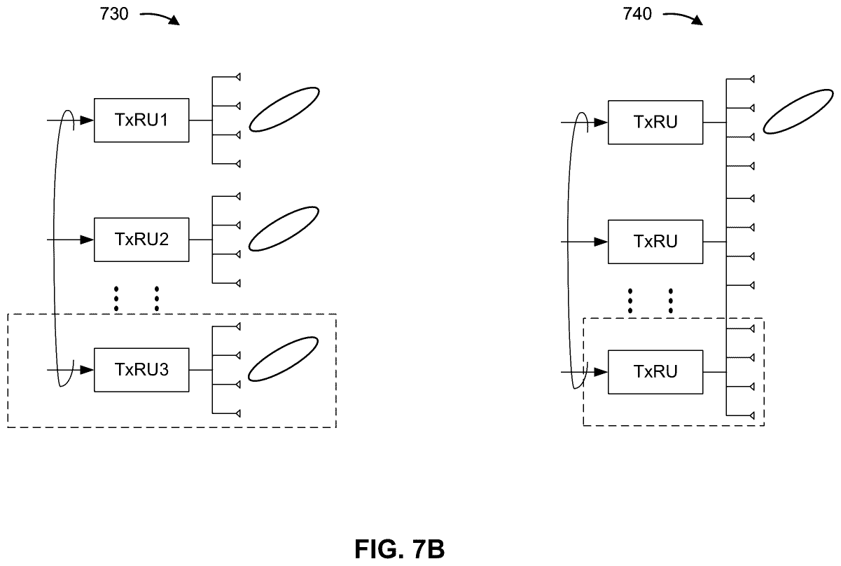

FIGS. 7A-7B are diagrams illustrating examples of CSI-RS beam management procedures, in accordance with the present disclosure. As shown in FIG. 7A, a UE 120 is in communication with a network node 110 in a wireless network (e.g., wireless network 100). However, the devices shown in FIG. 7A are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 7A, example 700 may include a network node 110 (e.g., one or more network node devices such as an RU, a DU, and/or a CU, among other examples) and a UE 120 communicating to perform beam management using CSI-RSs. Example 700 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 7 and example 700, CSI-RSs may be configured to be transmitted from the network node 110 to the UE 120. The CSI-RSs may be configured to be periodic (e.g., using RRC signaling), semi-persistent (e.g., using MAC-CE signaling), and/or aperiodic (e.g., using DCI).

The first beam management procedure may include the network node 110 performing beam sweeping over multiple transmit (Tx) beams. The network node 110 may transmit a CSI-RS using each transmit beam for beam management. To configure the UE 120 to perform receive (Rx) beam sweeping, the network node may use a transmit beam to transmit (e.g., with repetitions) each CSI-RS at multiple times within the same reference signal (RS) resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 700 has been described in connection with CSI-RSs, the first beam management process may also use synchronization signal blocks (SSBs) for beam management in a similar manner as described above.

As shown in FIG. 7A, example 710 may include a network node 110 and a UE 120 communicating to perform beam management using CSI-RSs. Example 710 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 7A and example 710, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 7A, example 720 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 7 and example 720, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To configure the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

In some cases, as shown in FIG. 7B and by reference number 730, an on/off capabilities of the network node 110 may be associated with a logical antenna port associated with a plurality of transmit receive units (TxRUs) (such as TxRU1, TxRU2, and TxRU3), and the logical antenna port may be turned on or off. This may be referred to as Type 1 spatial domain (SD) adaptation. In Type 1 SD adaptation, a TxRU can be activated or deactivated. In some other cases, referred to as Type 2 SD adaptation and shown by reference number 740, the configuration of physical antenna elements for CSI-RS or PDSCH is adapted. This type of adaptation may be useful for FR2, where the number of TxRUs at the network node is limited (such as 1 or 2 TxRUs). In Type 2 SD adaptation, the number of logical antenna ports may remain unchanged while the number of physical antenna elements can be adapted, hence impacting beamforming gain.

In some cases, such as from a CSI perspective, Type 1 SD adaptation may be the adaptation of antenna ports or transceiver chains at the network node 110. In contrast, Type 2 SD adaptation may be the adaptation of transmission power offset values between a CSI-RS and an SSB.

In some cases, one non-zero power (NZP) CSI-RS resource configuration for channel measurement within one resource setting corresponding to more than one spatial domain adaptation pattern may be supported. A spatial domain adaptation pattern may indicate a set of antenna elements or logical antenna ports to be activated or deactivated. In some cases, a resource set with multiple resources may be configured within a resource setting, where each resource is associated with only one spatial domain adaptation pattern. In some other cases, for a resource configured in a resource set within a resource setting, the resource can be associated with more than one spatial domain adaptation pattern. One or more resources can be configured in the resource set for channel measurement. In some cases, one CSI report configuration may include multiple CSIs report sub-configurations, where each sub-configuration corresponds to a single spatial domain adaptation pattern. A “sub-configuration” may refer to a configuration of CSI-RS resources that indicates reduced configurations. For example, a UE may use the same set of CSI-RS resources for CSI measurements for different adaptation configurations. In some aspects, the UE may derive CSI for reduced configurations from a CSI-RS resource with a higher quantity of reports, where the reduced configuration is indicated via a sub-configuration. For a sub-configuration of a CSI report configuration, the UE 120 may be configured with a port subset indication (e.g., a bitmap). The UE 120 may derive a reduced NZP CSI-RS resource from the corresponding NZP CSI-RS resource configured in the CSI-RS resource set of channel management. Configurations of CSI-RS resources and CSI-RS port configurations, including reduced configurations corresponding to spatial domain adaptation patterns, are described elsewhere herein.

In some cases, a CSI feedback (CSF) framework may include multiple steps. A first step (e.g., step 1) may be associated with CSF for adaptation of spatial elements. A second step (e.g., step 2) may be associated with identifying or transmitting a physical downlink shared channel (PDSCH) with a suitable configuration of spatial elements. In some cases, for a CSI report configuration with L sub-configuration(s), a framework that enables a UE to report N CSI(s) in one reporting instance, where the N CSI(s) are associated with N sub-configuration(s) from L (where 1≤N≤L) and each CSI corresponds to one sub-configuration, may be supported. N=1 may refer to single-CSI signaling while N>1 may refer to multi-CSI signaling.

In some cases, for a CSI report configuration, for each sub-configuration for Type 1 SD adaptation, at least the following may be included: one or more parameters in a codebook configuration (CodebookConfig), and a port subset indication or resource grouping. The one or more parameters in the codebook configuration may include, for example, n1-n2, and ng for multi-panel. In some cases, the one or more parameters may also include a rank restriction, a codebook subset restriction, and/or supported codebook types for a precoding matrix indicator (PMI) (e.g., Type-I or Type-II). A codebook subset restriction may be indicated via a CodebookSubsetRestriction parameter. A codebook subset restriction may indicate indices (e.g., for a codebook) that are restricted from consideration of a PMI computation. For type II codebooks, the codebook subset restriction may restrict a maximum amplitude that is allowed for one or more vector groups. For an enhanced type II codebook, the codebook subset restriction may restrict maximum average amplitude coefficients that are allowed for one or more vector groups.

The port subset indication or resource grouping may indicate, for example, a report quantity, a report frequency configuration (reportFreqConfiguration), and/or whether it is explicitly provided or can also be derived (e.g., from the CodebookConfig and/or from the CSI-RS resource configuration). For a CSI report configuration, at least the following can be included for each sub-configuration for Type 2 SD adaptation: an NZP CSI-RS resource set for channel measurement, where different resources can have different power offsets between a CSI-RS and SSB. In some cases, a report quantity can also be included in the CSI report configuration.

In one example, a CSI report configuration for Type 1 SD adaptation in accordance with a port subset indication may have three sub-configurations. The CSI report configuration may have a 32-port NZP CSI-RS resource set (for channel measurement). A first sub-configuration (sub-configuration 1) may have a first spatial domain adaptation pattern (spatial domain adaptation pattern 1) and may have a first codebook configuration (codebook configuration 1) with (N1, N2)=(8, 2). A second sub-configuration (sub-configuration 2) may have a second spatial domain adaptation pattern (spatial domain adaptation pattern 2) and may have a second codebook configuration (codebook configuration 2) with (N1, N2)=(8, 1). Additionally, the second sub-configuration may have 16-port NZP CSI-RS resource(s), where each resource is a subset of a 32-port CSI-RS resource in a CSI-RS resource set and corresponds to a uniform linear array (ULA) with (N1, N2) in codebook 2. A third sub-configuration (sub-configuration 3) may have a third spatial domain adaptation pattern (spatial domain adaptation pattern 3) and may have a third codebook configuration (codebook configuration 3) with (N1, N2)=(4, 1). The third sub-configuration may have 8-port NZP CSI-RS resource(s), where each resource is a subset of a 32-port CSI-RS resource in a CSI-RS resource set and corresponds to a ULA with (N1, N2) in codebook 3. In some cases, the resource subset may be determined based at least in part on a port subset indication. The network node 110 may transmit a CSI-RS using a 32-port NZP CSI-RS resource. The UE 120 may measure the 32-port NZP CSI-RS resource, and may derive CSI from the measurement. The CSI may relate to at least one of the 32-port NZP CSI-RS resource or one or more of the sub-configurations, depending on which of the sub-configurations is active for the CSI reporting. In Type 2 SD adaptation, the CSI report configuration may indicate a set of P-port CSI-RS resources for channel measurement, and may indicate one or more sub-configurations, where each sub-configuration indicates a set of CSI resource index identifiers corresponding to one or more CSI-RS resources of the set of P-port CSI-RS resources. In Type 2 SD adaptation, the network node 110 may transmit CSI-RSs using each CSI-RS resource indicated by any active sub-configuration of the one or more sub-configurations.

In another example, a CSI report configuration for Type 1 SD adaptation, in accordance with resource grouping may have three sub-configurations. The CSI report configuration may have a 32-port NZP CSI-RS resource set (for channel measurement). A first sub-configuration (sub-configuration 1) may have a first spatial domain adaptation pattern (spatial domain adaptation pattern 1) and may have a first codebook configuration (codebook configuration 1) with (N1, N2)=(8, 2). A second sub-configuration (sub-configuration 2) may have a second spatial domain adaptation pattern (spatial domain adaptation pattern 2) and may have a second codebook configuration (codebook configuration 2) with (N1, N2)=(8, 1). Additionally, the second sub-configuration may have a 16-port NZP CSI-RS resource set for channel measurement. A third sub-configuration (sub-configuration 3) may have a third spatial domain adaptation pattern (spatial domain adaptation pattern 3) and may have a third codebook configuration (codebook configuration 3) with (N1, N2)=(4, 1). Additionally. the third sub-configuration may have an 8-port NZP CSI-RS resource set for channel measurement. In some cases, there may be no relationship between the resources in the different sub-configurations.

As described in 3GPP Technical Specification (TS) 38.321, Release 17, section 5.18.6, for reporting on a physical uplink control channel (PUCCH), the UE may receive an activation command via a MAC-CE. The network may activate and deactivate the configured semi-persistent CSI reporting on the PUCCH of a serving cell by sending the SP CSI reporting on a PUCCH activation/deactivation MAC-CE. The configured semi-persistent CSI reporting on the PUCCH may be initially deactivated upon configuration and after a handover. In this case, if the MAC entity receives an SP CSI reporting on PUCCH activation/deactivation MAC-CE on a serving cell, the MAC entity may indicate, to lower layers, the information regarding the SP CSI reporting on PUCCH activation/deactivation MAC-CE. In some cases, the SP CSI on PUCCH activation/deactivation MAC-CE may be identified by a MAC sub header with a logical channel ID (LCID). The MAC sub header may have a serving cell ID field, a bandwidth part (BWP) ID field, an Si field, and a reserved bit (R) field, as described in as described in 3GPP TS 38.321 section 6.1.3.16, Release 17.

In some cases, a UE may receive triggering information for reporting CSI. In some cases, the UE may receive DCI that indicates for the UE to aperiodically report CSI via a physical uplink shared channel (PUSCH). A list of trigger states may be configured in a CSI aperiodic trigger state list (CSI-AperiodicTriggerStateList), and each trigger state included in the list of trigger states may include a list of associated reporting settings. In some other cases, the UE may receive DCI that indicates for the UE to semi-persistently report CSI via the PUSCH. A list of trigger states may be configured in a CSI semi-persistent state list (CSI-SemiPersistentOnPUSCH-TriggerStateList), and each trigger state included in the list of trigger states may include a list of associated reporting settings. In some other cases, the UE may receive a MAC-CE that indicates for the UE to semi-persistently report CSI via a PUCCH. In some cases, for a CSI report configuration with L sub-configuration(s), the UE may be configured to report N CSI(s) in a single reporting instance, where the N CSI(s) are associated with N sub-configuration(s) from L (where 1≤N≤L) and each CSI corresponds to a single sub-configuration.

As indicated above, FIGS. 7A-7B are provided as examples. Other examples may differ from what is described with regard to FIGS. 7A-7B.

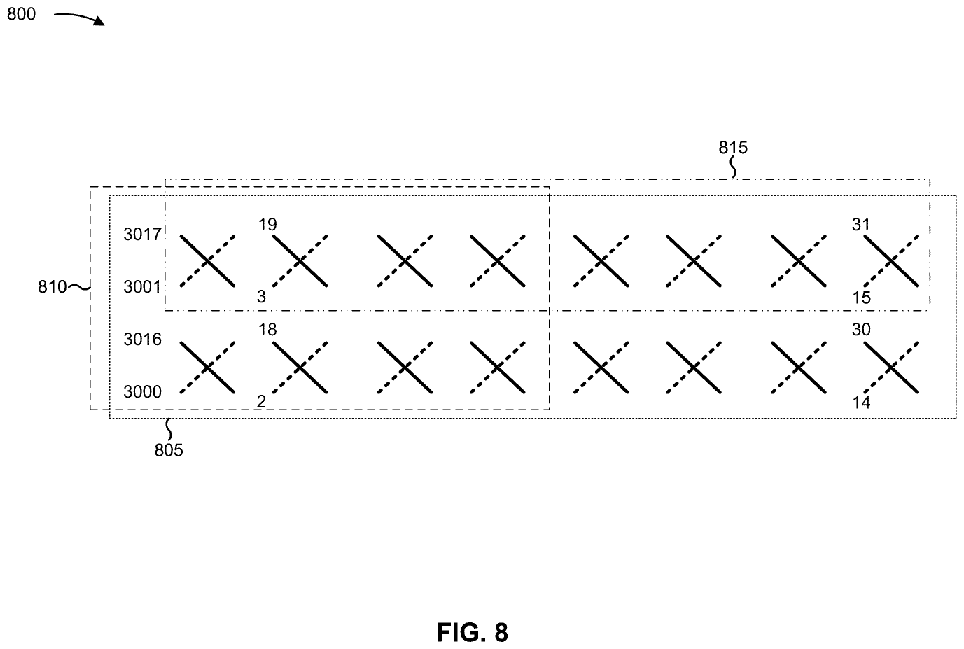

FIG. 8 is a diagram illustrating an example 800 of CSI-RS ports, in accordance with the present disclosure. A CSI-RS port may be referred to as a CSI-RS antenna port. CSI-RS ports may be indicated by a CSI-RS resource configuration. The CSI-RS ports may be associated with port numbers. A CSI-RS port's number may be based at least in part on a CSI-RS sequence index, a code division multiplexing (CDM) group size, and/or a total number of CSI-RS ports, among other examples. CSI-RS ports may be numbered starting at 3000. As an example, CSI-RS ports may be numbered as {3000, 3001} for 2 CSI-RS ports, {3000, 3001, 3002, 3003} for 4 CSI-RS ports, {3000, 3001, . . . , 3007} for 8 CSI-RS ports, {3000, 3001, . . . , 3011} for 12 CSI-RS ports, {3000, 3001, . . . , 3015} for 16 CSI-RS ports, {3000, 3001, . . . , 3023} for 24 CSI-RS ports, and {3000, 3001, . . . , 3031} for 32 CSI-RS ports, among other examples.

A UE 120 may calculate a CQI of CSF using CSI-RS port numbering. For example, the CSI-RS port numbering may allow the UE 120 to identify or assume an antenna relationship between the CSI-RS and a PDSCH. In particular, for CQI calculation, the UE 120 may assume that PDSCH signals on antenna ports in the set [1000, . . . , 1000+v−1] for v layers would result in signals equivalent to corresponding symbols transmitted on antenna ports [3000, . . . , 3000+P−1], as given by

$$[ \begin{matrix}{y}^{( 3000 )} ( i ) \\ … \\ {y}^{( 3000 + P - 1 )} ( i )\end{matrix} ] = W ( i ) [ \begin{matrix}{x}^{( 0 )} ( i ) \\ … \\ {x}^{( ν - 1 )} ( i )\end{matrix} ] ,$$

where x(i)=[x⁽⁰⁾(i) . . . x^{(v-1)}(i)]^{T} is a vector of PDSCH symbols from a defined layer mapping, P is a number of CSI-RS ports, and W(i) is a precoding matrix. If only one CSI-RS port is configured, W(i) may be 1 (one). If the higher layer parameter reportQuantity in CSI-ReportConfig for which the CQI is reported is set to either ‘cri-RI-PMI-CQI’ or ‘cri-RI-LI-PMI-CQI’, W(i) may be the precoding matrix corresponding to the reported PMI applicable to x(i). If the higher layer parameter reportQuantity in CSI-ReportConfig for which the CQI is reported is set to ‘cri-RI-CQI’, W(i) may be the precoding matrix corresponding to a procedure described in Clause 5.2.1.4.2 of 3GPP TS 38.214, Release 17. If the higher layer parameter reportQuantity in CSI-ReportConfig for which the CQI is reported is set to ‘cri-RI-i1-CQI’, W(i) is the precoding matrix corresponding to the reported ii according to the procedure described in Clause 5.2.1.4.2 of 3GPP TS 38.214, Release 17.

As shown by reference number 805, a first CSI-RS port configuration corresponding to a first CSI-RS resource is shown. The first CSI-RS port configuration may include 32 CSI-RS ports (P=32), numbered 3000 through 3031. The first CSI-RS resource may be considered a 32-port NZP CSI-RS resource, and may be configured (via a first configuration) in an NZP CSI-RS resource set for channel management with CSI-RS port configuration (N1, N2) (8, 2), corresponding to 2 rows and 8 columns of CSI-RS ports. Each of the CSI-RS ports of the first CSI-RS port configuration may be referred to as active CSI-RS ports, because each of these CSI-RS ports may be measured to compute CSI using a CSI-RS transmitted in accordance with the first CSI-RS port configuration. “Active CSI-RS port” may be used interchangeably with “CSI-RS port for CSI measurement” herein. A CSI-RS resource may be configured for channel measurement, meaning that the CSI-RS resource is used to derive CSI for a channel. Other types of CSI-RS resource may include zero-power CSI-RS resources and CSI-RS resources for interference measurement.

As shown by reference number 810, a second CSI-RS port configuration that is a subset (e.g., a proper subset) of the first CSI-RS port configuration is shown. For example, the second CSI-RS port configuration may be configured, via a second configuration (e.g., a sub-configuration), using a port subset indication. The port subset indication may include a P-bit bitmap that indicates which CSI-RS ports, of the first CSI-RS port configuration, are active (that is, used for measurement of CSI) in the second CSI-RS port configuration. In this example, the 32-bit bitmap may include values (1 1 1 1 1 1 1 1 0 0 0 0 0 0 0 0 1 1 1 1 1 1 1 1 0 0 0 0 0 0 0 0) which indicates that CSI-RS ports {3000, 3001, 3002, . . . , 3007, 3016, 3017, . . . , 3023} are used for CQI computation. The remaining CSI-RS ports may not be used for CSI measurement or CQI computation, and thus may be referred to as inactive in this context. The second CSI-RS port configuration may be associated with a second CSI-RS resource that is associated with the first CSI-RS resource and is a subset of the first CSI-RS resource. “Measurement of a CSI-RS” or “measurement of a channel” may include taking one or more samples at a time and/or frequency and/or spatial resource identified by a CSI-RS resource. These samples can then be used to determine CSI.

As shown by reference number 815, a third CSI-RS port configuration that is a subset (e.g., a proper subset) of the first CSI-RS port configuration is shown. For example, the third CSI-RS port configuration may be configured, via a third configuration (e.g., a sub-configuration), using a port subset indication. The port subset indication may include a P-bit bitmap that indicates which CSI-RS ports, of the first CSI-RS port configuration, are active in the second CSI-RS port configuration. In this example, the 32-bit bitmap may include values (0 1 0 1 0 1 0 1 0 1 0 1 0 1 0 1 0 1 0 1 0 1 0 1 0 1 0 1 0 1 0 1) which means that odd CSI-RS ports {3001, 3003, 3005, . . . , 3015, 3017, 3019, . . . , 2031} are used for CQI computation. The third CSI-RS port configuration may be associated with a third CSI-RS resource that is associated with the first CSI-RS resource and is a subset of the first CSI-RS resource.

A network node 110 may transmit a CSI-RS in accordance with the first CSI-RS resource (referred to as transmitting the first CSI-RS resource). The UE 120 may determine CSI (e.g., compute CQI) by measuring the CSI-RS and applying parameters of the second configuration and/or the third configuration. For example (such as in Type 1 SD adaptation and power domain adaptation), the UE 120 may determine CSI for any active sub-configuration of a CSI-RS resource (or a CSI-RS resource set) using a CSI-RS transmitted in accordance with the CSI-RS resource. In some aspects (such as in Type 2 SD adaptation) the network node 110 may transmit CSI-RSs in accordance with each activated sub-configuration.

As indicated above, FIG. 8 is provided as an example. Other examples may differ from what is described with regard to FIG. 8.

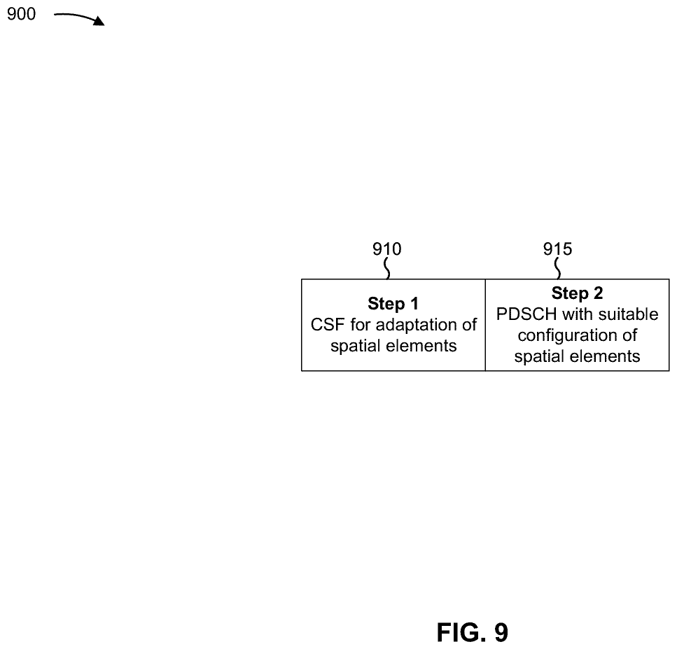

FIG. 9 is a diagram illustrating an example 900 of adaptation in the spatial domain, in accordance with the present disclosure. Example 900 may include reporting of CSF (shown by reference number 910) and configuration and/or transmission of a PDSCH with a configuration of spatial elements (shown by reference number 915).

As shown by reference number 910, the UE 120 may report CSF. For example, the UE 120 may report the CSF for adaptation (e.g., activation, deactivation, reconfiguration) of spatial elements, such as antennas. A network node (e.g., a network node 110) may configure a CSI report configuration with multiple sub-configurations. Each sub-configuration may correspond to a CSI-RS antenna port configuration (e.g., for Type 1 SD adaptation) or to a list of CSI-RS resources (e.g., for Type 2 SD adaptation). The UE 120 may measure and report CSI according to all of the sub-configurations or according to a subset of the sub-configurations. For example, the network node may provide an indication of which sub-configurations are to be reported. As shown by reference number 915, the network node may transmit a PDSCH with a suitable configuration of spatial elements. For example, the network node may switch among different configurations of active spatial elements based on CSI reports (e.g., CSF) from the UE 120.

As indicated above, FIG. 9 is provided as an example. Other examples may differ from what is described with regard to FIG. 9.

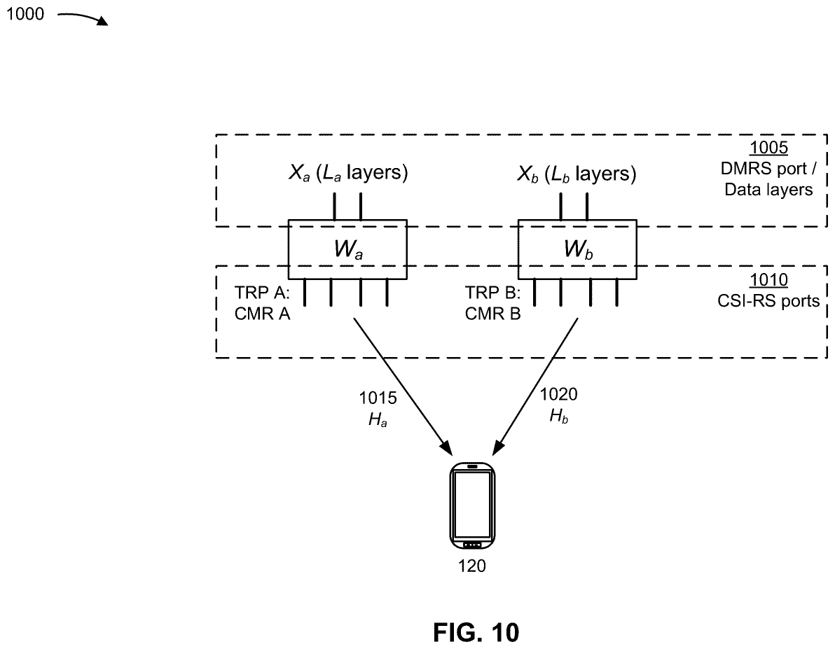

FIG. 10 is a diagram illustrating an example 1000 of non-coherent joint transmission (NCJT) for multiple TRPs, in accordance with the present disclosure. As shown in FIG. 10, a UE 120 may communicate with a first TRP (e.g., a TRP A) and a second TRP (e.g., a TRP B), in a similar manner as described elsewhere herein, such as in connection with FIGS. 4 and 5.

In some examples, for NCJT that is based on spatial domain multiplexing (SDM), data may precoded separately for different TRPs. For example, a precoder A (shown in FIG. 10 as Wₐ) may be used by TRP A, and a precoder B (shown in FIG. 10 as W_{b}) may be used by TRP B. For example, as shown by reference number 1005, TRP A and the TRP B may be associated with different data and/or DMRS ports. For example, TRP A may be associated with data Xₐ (e.g., associated with Lₐ layers) and the TRP B may be associated with data X_{b} (e.g., associated with L_{b} layers). The separate precoding may be expressed as

$$[ \begin{matrix}{W}_{a} & 0 \\ 0 & {W}_{b}\end{matrix} ] [ \begin{matrix}{X}_{a} \\ {X}_{b}\end{matrix} ] = [ \begin{matrix}{W}_{a} {X}_{a} \\ {W}_{b} {X}_{b}\end{matrix} ] .$$

As shown by reference number 1010, transmissions from respective TRPs may be associated with different CSI-RS ports. For example, an NCJT from the TRP A and the TRP B may include a first transmission over a first channel 1015 (e.g., shown as Hₐ in FIG. 10) and a second transmission over a second channel 1020 (e.g., shown as H_{b} in FIG. 10). The NCJT as received by the UE 120 may be expressed as:

$$[ \begin{matrix}{H}_{a} & {H}_{b}\end{matrix} ] [ \begin{matrix}{W}_{a} {X}_{a} \\ {W}_{b} {X}_{b}\end{matrix} ] + I + N ,$$

where I is interference associated with the NCJT and N is noise associated with the NCJT.

In some examples, when a network node 110 configures the UE 120 for multi-TRP operation, the network node 110 may configure the UE 120 with an NZP CSI-RS resource set that the UE 120 may use for channel measurements. A CSI-RS resource for channel measurement may be referred to as a channel measurement resource (CMR). In such examples, the NZP CSI-RS resource set may include a quantity of resources, Kₛ, which may be divided into separate resource groups for each TRP. The resources Kₛ may be referred to as a resource set or a CMR set.

For example, a first resource group (e.g., a first CMR group) may include a first quantity of resources, K₁, for performing channel measurements with respect to a first TRP (e.g., the TRP A), and a second resource group (e.g., a second CMR group) may include a second quantity of resources, K₂, for performing channel measurements with respect to a second TRP (e.g., the TRP B). Furthermore, the first resource group and the second resource group may each include one or more resources (for example, such that K₁≥1 and K₂≥1) and the NZP CSI-RS resource set may include up to a maximum of 8 resources (for example, such that K₁+K₂=Kₛ and 2≤Kₛ≤8). Accordingly, when the UE 120 is configured with the NZP CSI-RS resource set, the UE 120 may be configured to transmit, to the network node 110, a report that indicates N resource pairs associated with best channel measurements. In such examples, each resource pair may include a first resource (for example, a first CMR) from the first resource group and a second resource (for example, a second CMR) from the second resource group, where N∈{1,2}. For example, the report provided by the UE 120 may indicate the N resource pairs associated with best channel measurements associated with the CMRs in the respective resource groups. This may enable the network node 110 to select the best beam pairs associated with the two TRPs for multi-TRP operation.

In some examples, the resource groups (e.g., the CMR groups) may be associated with the same CSI-RS port configuration (e.g., in terms of (N1, N2) values for single panel, or in terms of (Ng, N1, N2) values for multi-panel). N1 may indicate a number of rows for an antenna panel array, N2 may a number of columns for the antenna panel array, and Ng may indicate a number of antenna panels (e.g., for multi-panel). Each TRP may use the same CSI-RS port configuration. In some examples, the UE 120 may perform single TRP CSI estimation (e.g., for a given TRP) using a CMR that is included in a resource pair. In other examples, the UE 120 may perform single TRP CSI estimation (e.g., for a given TRP) using only CMRs that are not included in a resource pair. The UE 120 may be configured with one (e.g., a single) interference measurement resource (IMR) (e.g., a CSI-RS for interference measurement (CSI-IM)) for each hypothesis (e.g., for each single TRP hypothesis and each multi-TRP hypothesis). As used herein, a “hypothesis” may refer to a measurement of a CMR (e.g., for single TRP) or a resource pair (e.g., for multi-TRP). In other words, a multi-TRP hypothesis may be indicated via a CSI estimation being associated with a resource pair (e.g., a CMR pair), whereas a single TRP hypothesis may be indicated via a CSI estimation being associated with a single CMR.

The UE 120 may be configured for rank indicator (RI) restrictions (also referred to as rank restrictions) for respective hypothesis types. A rank restriction (or RI restriction) may be a restriction associated with a rank indicator. For example, the rank restriction may indicate a set of one or more ranks that are restricted from usage for an RI computation by the UE 120. For example, the UE 120 may be configured with one (e.g., a single) rank restriction for single TRP hypotheses and one (e.g., a single) rank restriction for multi-TRP hypotheses (e.g., rank restrictions may be configured per CSI hypothesis type). The UE 120 may be configured with codebook subset restrictions for respective resource groups. For example, the UE 120 may be configured with one (e.g., a single) codebook subset restriction for a first resource group and one (e.g., a single) codebook subset restriction for a second resource group (e.g., codebook subset restrictions may be configured per-TRP). In some examples, the UE 120 may report CSI in accordance with one or more modes. The UE 120 may receive an indication of a given mode to be associated with CSI reporting (e.g., via an RRC parameter). In a first mode, the UE 120 may report one (e.g., a single) best multi-TRP hypothesis (e.g., a best resource pair) and X best single TRP hypotheses. A value of X may be configured and may have a value of 0, 1, 2, and/or another value. If X has a value greater than 1 (e.g., 2 or higher), then the UE 120 may report CSI for at least one CMR from each resource group (e.g., one or more CMRs from a first resource group and one or more CMRs from a second resource group). In a second mode, the UE 120 may report one (e.g., a single) best CSI from all single TRP and multi-TRP hypotheses.

For example, the UE 120 may transmit a CSI report indicating CSI feedback (e.g., for single TRP CSI and multi-TRP CSI associated with a given CSI report setting and in the same CSI report). For example, for Type I, Type II, Enhanced Type II, and Further Enhanced Type II Port Selection CSI feedback on PUSCH, a CSI report may include two parts (e.g., Part 1 and Part 2). Part 1 may have a fixed payload size and may be used to identify the number of information bits in Part 2. Part 1 may be transmitted in its entirety before Part 2. For Type I CSI feedback, Part 1 may indicate RI (if reported), a CSI-RS resource indicator (CRI) (if reported), and/or CQI for a first codeword (if reported). Part 2 may indicate a PMI (if reported), a layer indicator (LI) (if reported) and/or a CQI for a second codeword (if reported) when RI is larger than 4. For a CSI report setting (e.g., a CSI-ReportConfig) configured with codebookType set to ‘type1-SinglePanel’ and the corresponding CSI-RS resource set for channel measurement configured with two resource groups and N resource pairs (e.g., indicating that the CSI-RS resource set is configured for multi-TRP CSI), Part 1 may include RI(s), CRI(s), CQI(s) for the first codeword and may be zero padded to a fixed payload size (if needed). Part 2 may include the CQI(s) for the second codeword (if reported) when RI is larger than 4, LIs (if reported), and PMI(s). As used herein, “CSI” or CSI feedback” may refer to information indicated via a CSI report, such as an RI, a CRI, a CQI, a PMI, and/or an LI, among other examples.

As described elsewhere herein, a network node 110 may use spatial domain adaptation to deactivate one or more antenna panels (antenna elements, spatial elements, or ports), such that fewer antenna panels or antenna elements are active for improved power savings. For example, the network node 110 may configure the UE 120 to report CSI for different spatial domain adaptation patterns using sub-configurations of a CSI report setting (e.g., where the sub-configurations are associated with respective spatial domain adaptation patterns of the network node). However, as described above, for multi-TRP CSI, each TRP may be associated with the same CSI-RS port configuration. In other words, each TRP may use the same CSI-RS ports and/or the same antenna configuration to configure the UE 120 to report CSI for an NCJT from multiple TRPs. Because the multiple TRPs may use the same CSI-RS port configuration for multi-TRP CSI, the network node 110 may be unable to configure CSI reporting for spatial domain adaptation in multi-TRP scenarios (e.g., because the network node 110 may be restricted to configuring each TRP with the same CSI-RS port configuration and therefore may be unable to perform spatial domain adaptation for only one of the TRPs). Therefore, the network node 110 may be unable to obtain CSI for spatial domain adaptation. This may result in increased network power usage in multi-TRP scenarios because the network node 110 may not employ spatial domain adaptation (e.g., because the network node 110 may not receive CSI for spatial domain adaptation indicating which antenna elements and/or which CSI-RS ports are suitable for deactivation).

Alternatively, if the network node 110 is utilizing spatial domain adaptation for one or more TRPs, the network node 110 may be unable to perform multi-TRP operations. For example, if the network node 110 configures a CSI report setting for a given TRP to enable the network node 110 to obtain CSI for spatial domain adaptation, then the network node 110 may be unable to configure a CSI report setting for the given TRP to enable the network node 110 to obtain multi-TRP CSI. In other words, the network node 110 may be unable to configure both a CSI framework for spatial domain adaptation and a CSI framework for multi-TRP operations. This may decrease flexibility for operations via the network node 110 because the network node 110 may choose to support either spatial domain adaptation for improved power savings or multi-TRP operations.

FIG. 11 is a diagram of an example 1100 associated with CSI for spatial domain adaptation, in accordance with the present disclosure. As shown in FIG. 11, one or more network nodes 110 (e.g., a base station, a TRP, a CU, a DU, and/or an RU) may communicate with a UE 120. In some aspects, the network node(s) 110 and the UE 120 may be part of a wireless network (e.g., the wireless network 100). The UE 120 and the network node(s) 110 may have established a wireless connection prior to operations shown in FIG. 11.

In some aspects, a network node 110 may be associated with one or more TRPs (shown in FIG. 11 as TRP A and TRP B). In some aspects, the TRP A and the TRP B may be associated with (e.g., included in or belong to) the same cell. In other aspects, the TRP A and the TRP B may be associated with (e.g., included in or belong to) different cell. In some aspects, the network node 110 may be a control entity for the TRPs. For example, the network node 110 may be a CU or a DU and the TRPs may be RUs. As another example, as shown in FIG. 11, the TRPs may be included in the network node 110. Although FIG. 11 shows two TRPs, aspects described herein may be similarly applied to scenarios associated with more than two TRPs.

In some aspects, actions described herein as being performed by a network node 110 may be performed by multiple different network nodes. For example, configuration actions may be performed by a first network node (for example, a CU or a DU), and radio communication actions may be performed by a second network node (for example, a TRP, a DU, or an RU). As used herein, the network node 110 “outputting” or “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU outputting or transmitting a communication to an RU (or a TRP) and the RU (or the TRP) transmitting the communication to the UE 120, or may include causing the RU (or the TRP) to transmit the communication (e.g., triggering transmission of a physical layer reference signal). Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU (or a TRP) and the RU (or the TRP) transmitting the communication to the DU. Similarly, the network node 110 “obtaining” a communication may refer to receiving a transmission carrying the communication directly (for example, from the UE 120 to the network node 110) or receiving the communication (or information derived from reception of the communication) via one or more other network nodes or devices.

In some aspects, as shown by reference number 1105, the UE 120 may transmit, and the network node 110 may receive, a capability report. The UE 120 may transmit the capability report via an uplink communication, a UE assistance information (UAI) communication, an uplink control information (UCI) communication, an uplink MAC-CE communication, an RRC communication, a physical uplink control channel (PUCCH), and/or a physical uplink shared channel (PUSCH), among other examples. The capability report may indicate one or more parameters associated with respective capabilities of the UE 120. The one or more parameters may be indicated via respective information elements (IEs) included in the capability report.

The capability report may indicate whether the UE 120 supports a feature and/or one or more parameters related to the feature. For example, the capability report may indicate a capability and/or parameter for being configured to report CSI for spatial domain adaptation and multi-TRP scenarios. As another example, the capability report may indicate a capability and/or parameter for supporting being configured with a sub-configuration of a CSI report setting that enables CSI for spatial domain adaptation and multi-TRP scenarios. One or more operations described herein may be based on capability information of the capabilities report. For example, the UE 120 may perform a communication in accordance with the capability information, or may receive configuration information that is in accordance with the capability information. In some aspects, the capability report may indicate UE support for being configured with a sub-configuration of a CSI report setting that configures different configuration information for CMR groups or pairs of resources (e.g., different from configuration information indicated by the CSI report setting). For example, the capability report may indicate UE support for being configured with a sub-configuration that indicates one or more parameters to enable spatial domain adaptation and multi-TRP CSI, as described in more detail elsewhere herein.

As shown by reference number 1110, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some aspects, the configuration information may include a CSI configuration. For example, the configuration information may include a CSI report configuration or a CSI report setting, among other examples. In some aspects, the configuration information may indicate one or more CSI-RS resource configurations. The one or more CSI-RS resource configurations may be NZP CSI-RS resource configurations. In some aspects, the one or more CSI-RS resource configurations may be, or may be included in, one or more CMR configurations. Additionally or alternatively, the one or more CSI-RS resource configurations may be, or may be included in, one or more IMR configurations. The configuration information may indicate a CSI report configuration or a CSI reporting setting. The CSI report configuration or the CSI reporting setting may indicate the multiple CSI-RS resource configurations. In some aspects, the one or more CSI-RS resource configurations may be included in one or more CSI-RS resource sets.

A CSI report configuration may be configured per bandwidth part (BWP). A CSI-RS resource set may have Kₛ resources with the same quantity of CSI-RS ports. If Kₛ=1, each resource may contain 32 CSI-RS ports (for example, if the network node 110 associated with the CSI report configuration includes 32 antenna ports). If Kₛ=2, each resource may contain at most 16 CSI-RS ports. For Kₛ=2 to 8, each resource may contain up to 8 CSI-RS ports. A P-port resource has ports labeled from 3000 to 3000(P−1).

The CSI report configuration may include a CSI resource setting for a CMR, a CSI resource setting for CMR and CSI-IM or NZP interference measurement resource (IMR), and a CSI resource setting for CMR and CSI-IM and NZP-IMR. A CMR may be associated with estimating channel conditions. For example, the UE 120 may measure a CMR to estimate the channel conditions (for example, the UE 120 may measure a CMR to perform a channel measurement, such as an RSRP measurement). An IMR or a CSI-IM resource may be associated with estimating interference associated with a channel. For example, the UE 120 may measure an IMR or a CSI-IM resource to estimate the interference (for example, the UE may measure an IMR to perform an interference measurement). Each resource setting may have one active resource set, and each resource set may have one or more resources (N resources). A CSI report configuration may also be referred to as a “CSI report setting.”

The CSI report configuration may include a codebook configuration that includes a codebook type, such as Type I single panel, Type I multi-panel, Type II single panel, Type II port selection, or Type II enhanced port selection. A codebook type may have an antenna configuration of Ng panels with dimensions N1 and N2. The codebook type may be associated with a discrete Fourier transform (DFT) beam restriction. The codebook type may have an RI restriction, or a limit on the quantity of layers. The CSI report configuration may be of a report configuration type (for example, periodic, semi-persistent, aperiodic).

In some aspects, a CSI-RS resource set configured by the CSI report setting may be associated with a first one or more CSI-RS resources included in a first resource group (e.g., a first CMR group) and a second one or more CSI-RS resources included in a second resource group (e.g., a second CMR group). For example, a first resource group (e.g., a first CMR group) may include a first quantity of resources, K₁, for performing channel measurements with respect to a first TRP (e.g., the TRP A), and a second resource group (e.g., a second CMR group) may include a second quantity of resources, K₂, for performing channel measurements with respect to a second TRP (e.g., the TRP B). Furthermore, the first resource group and the second resource group may each include one or more resources (for example, such that K₁≥1 and K₂≥1), and the NZP CSI-RS resource set may include up to a maximum of 8 resources (for example, such that K₁+K₂=Kₛ and 2≤Kₛ≤8). Accordingly, when the UE 120 is configured with the NZP CSI-RS resource set, the UE 120 may be configured to transmit, to the network node 110, a report that indicates N resource pairs associated with best channel measurements. In such examples, each resource pair may include a first resource (for example, a first CMR) from the first resource group and a second resource (for example, a second CMR) from the second resource group, where N resource pairs∈{1,2}. For example, the report provided by the UE 120 may indicate the N resource pairs associated with best channel measurements associated with the CMRs in the respective resource groups. This may enable the network node 110 to select the best beam pairs associated with the two TRPs for multi-TRP operation.

The CSI report configuration may indicate (or include) one or more sub-configurations (e.g., L sub-configurations). A sub-configuration may indicate configuration information (e.g., one or more configuration parameters) that are associated with (e.g., specific to) a spatial domain adaptation pattern for multi-TRP operations. For example, a sub-configuration may configure the UE 120 to calculate and/or report CSI for spatial domain adaptation (e.g., Type 1 spatial domain adaptation and/or Type 2 spatial domain adaptation) and for multi-TRP. The sub-configuration may indicate configuration information (e.g., one or more configuration parameters) for one or more resource groups (e.g., one or more CMR groups) that is different than configuration information (e.g., one or more configuration parameters) for the one or more resource groups as indicated by the CSI report configuration.

For example, the sub-configuration may indicate first configuration information for the first resource group and second configuration information for the second resource group (e.g., where the first configuration information and the second configuration information are specific to the sub-configuration). The first configuration information and/or the second configuration information may be different than configuration information (e.g., one or more configuration parameters) for the one or more resource groups as indicated by the CSI report configuration. Additionally, or alternatively, the sub-configuration may indicate third configuration information associated with one or more pairs of resources (e.g., CMR pairs) from the first resource group and the second resource group. The third configuration information may be different than configuration information (e.g., one or more configuration parameters) for the one or more resource groups as indicated by the CSI report configuration.

In some aspects, the sub-configuration may indicate fourth configuration information that is common for the first resource group and the second resource group (e.g., but is different than the configuration information for the resource groups as indicated by the CSI report configuration). For example, the fourth configuration information may indicate a common CSI-RS port configuration. For example, the sub-configuration may include a parameter that indicates a CSI-RS port configuration ((N1, N2) for single panel and (N1, N2, Ng) for multi-panel) which is common for resources in the CMR groups. The common CSI-RS port configuration may be different than a CSI-RS port configuration indicated by the CSI report configuration. Additionally, or alternatively, the fourth configuration may indicate a common CSI-RS port subset indication. For example, the sub-configuration may include a parameter that indicates a port subset indication that is common for resources in CMR groups and/or for resources in a resource pair (e.g., a pair of CMRs).

Additionally, or alternatively, the fourth configuration information may indicate a common codebook subset restriction. For example, the sub-configuration may include a parameter that indicates a codebook subset restriction that may be common for the first resource group and the second resource group. Additionally, or alternatively, the fourth configuration information may indicate a common rank restriction for CSI computation using a single CSI-RS resource from the first resource group or the second resource group. For example, the sub-configuration may include a parameter that indicates a rank restriction (e.g., a common rank restriction) to be used when the UE 120 computes CSI using a single CMR. Additionally, or alternatively, the sub-configuration may include a parameter that indicates a rank restriction (e.g., a common rank restriction) to be used when the UE 120 uses a resource pair (e.g., a pair of CMRs) for CSI computation.

For example, the sub-configuration may include a first parameter that indicates a CSI-RS port configuration ((N1, N2) for single panel and (N1, N2, Ng) for multi-panel) which is common for resources in the CMR groups. The sub-configuration may include a second parameter that indicates a CSI-RS port subset indication that is common for resources in CMR groups and/or for resources in a resource pair (e.g., a pair of CMRs). The sub-configuration may include a third parameter that indicates a codebook subset restriction. The third parameter may indicate a common codebook subset restriction for the first resource group and the second resource group. Alternatively, the third parameter may indicate a first codebook subset restriction for the first resource group (e.g., the first configuration information described elsewhere herein may indicate the first codebook subset restriction) and a second codebook subset restriction for the second resource group (e.g., the second configuration information described elsewhere herein may indicate the second codebook subset restriction). For example, the third parameter may indicate a codebook subset restriction that may be different for resources in different CMR groups. The sub-configuration may include a fourth parameter that indicates a rank restriction (e.g., a common rank restriction) to be used when the UE 120 computes CSI using a single CMR (e.g., for single TRP CSI). The sub-configuration may include a fifth parameter that indicates a rank restriction (e.g., a common rank restriction) to be used when the UE 120 uses a resource pair (e.g., a pair of CMRs) for CSI computation (e.g., for multi-TRP). For example, the third configuration information may indicate rank restrictions for respective pairs of resources of the one or more pairs of resources.

As a result, the sub-configuration may enable CSI computation for reduced resources (e.g., for Type 1 spatial domain adaptation). The reduced resources may be derived from configured CSI-RS resources in the CSI-RS resource set for channel measurement and the port subset indication. CSI-RS resources associated with the same sub-configuration have the same CSI-RS port configuration (e.g., which may be different than the CSI-RS resources in the configured CSI-RS resource set). Furthermore, the sub-configuration may enable the UE 120 to implement CSI computation (e.g., for Type 1 spatial domain adaptation) via the sub-configuration in the same, or similar, manner as CSI computation for a multi-TRP CSI framework.

As another example, the sub-configuration may include a first one or more parameters for the first resource group (e.g., the first configuration information may indicate a first one or more parameters for a first CMR group). The sub-configuration may include a second one or more parameters for the second resource group (e.g., the second configuration information may indicate a second one or more parameters for a second CMR group). The sub-configuration may include a third one or more parameters for resource pairs (e.g., the second configuration information may indicate a third one or more parameters for the one or more resource pairs).

For example, the sub-configuration may indicate a first CSI-RS port configuration, a first port subset indication, a first codebook subset restrictions, and/or a first rank restriction for the first resource group (e.g., indicated by the first one or more parameters and/or the first configuration information). Additionally, the sub-configuration may indicate a second CSI-RS port configuration, a second port subset indication, a second codebook subset restrictions, and/or a second rank restriction for the second resource group (e.g., indicated by the second one or more parameters and/or the second configuration information). Additionally, the sub-configuration may indicate a rank restriction for respective pairs of resources (e.g., CMR pairs from the first resource group and the second resource group). As a result, the sub-configuration (e.g., that indicates different parameters for different resource groups) may enable additional flexibility for spatial domain adaptation because the network node 110 may configure different antenna port configurations for the TRP A and the TRP B.

CSI-RS resources included in a pair of resources may be configured by the CSI report configuration (e.g., by a CMR configuration), but may be associated with parameters for a corresponding resource group, as indicated by the sub-configuration. In other words, the CSI report configuration may configure one or more pairs of resources (e.g., one or more CMR pairs). For the sub-configuration, CSI-RS resources included in the one or more pairs of resources may be associated with one or more parameters indicated by the sub-configuration. For example, the sub-configuration may include a first one or more parameters for a first resource group and a second one or more parameters for the second resource group. The CSI report configuration may indicate that a pair of resources includes a first CSI-RS resource included in the first resource group and a second CSI-RS resource included in the second resource group. For the sub-configuration and the pair of resources, the first CSI-RS resource may be configured using the first one or more parameters and the second CSI-RS resource may be configured using the second one or more parameters.

In some aspects, the CSI-RS resource set may be associated with one or more CSI-RS resources for interference measurement (e.g., one or more CSI-IM resources or one or more IMRs). For example, the CSI report configuration may configure one or more CSI-RS resources for interference measurement to be associated with the one or more CSI-RS resources for channel measurement. In such examples, the one or more CSI-RS resources for interference measurement may be applicable to the sub-configuration. In other words, for each sub-configuration, the UE 120 may use the interference measurement resources that are associated with the channel measurement resources configured for an NZP CSI-RS resource set for channel measurement when computing CSI for single TRP or for multi-TRP hypotheses.

In some aspects, the sub-configuration may indicate the one or more pairs of resources (e.g., for Type 2 spatial domain adaptation). In such examples, the sub-configuration may indicate rank restrictions for respective pairs of resources of the one or more pairs of resources. In some aspects, the sub-configuration may indicate (or configure) the first resource group and the second resource group. For example, the sub-configuration may include a first list of one or more CSI-RS resource identifiers for channel measurement (e.g., to configure the first resource group). Additionally, the sub-configuration may include a second list of one or more CSI-RS resource identifiers for channel measurement (e.g., to configure the second resource group). The one or more pairs of resources may each include one CSI-RS resource from each resource group indicated by the sub-configuration. In such examples, the resource groups may be associated with the same CSI-RS port configuration (e.g., for Type 2 spatial domain adaptation).

As another example, the CSI report configuration may indicate (or configure) the first resource group and the second resource group. In such examples, the sub-configuration may include a first list of one or more CSI-RS resource identifiers for channel measurement from CSI-RS resource identifiers included in the first resource group. Additionally, the sub-configuration may include a second list of one or more CSI-RS resource identifiers for channel measurement from CSI-RS resource identifiers included in the second resource group. In such examples, the one or more pairs of resources may each include one CSI-RS resource from each list indicated by the sub-configuration.

The UE 120 may configure itself based at least in part on the configuration information. In some aspects, the UE may be configured to perform one or more operations described herein based at least in part on the configuration information.

In some aspects, the configuration information described in connection with reference number 1110 and/or the capability report described in connection with reference number 1105 may include information transmitted via multiple communications. Additionally, or alternatively, the network node 110 may transmit the configuration information, or a communication including at least a portion of the configuration information, before and/or after the UE 120 transmits the capability report. For example, the network node 110 may transmit a first portion of the configuration information before the UE 120 transmits the capability report, the UE 120 may transmit at least a portion of the capability report, and the network node 110 may transmit a second portion of the configuration information after receiving the capabilities report.

As shown by reference number 1115, the network node 110 (e.g., the TRP A and/or the TRP B) may transmit, and the UE 120 may receive, one or more signals via CMRs configured via the sub-configuration. As shown by reference number 1120, the UE 120 may calculate CSI based on, or in accordance with, the sub-configuration. For example, the UE 120 may select a codebook for CSI calculation using information indicated by the sub-configuration. In some aspects, the UE 120 may calculate the CSI in accordance with a multi-TRP framework (e.g., in a similar manner as described in connection with FIG. 10). For example, the UE 120 may measure a CMR to estimate the channel conditions (for example, the UE 120 may measure a CMR to perform a channel measurement, such as an RSRP measurement). The UE 120 may determine CSI using the measurements of respective CMRs. For example, the CSI may include one or more measurement values, an RI, a CRI, a CQI, a PMI, and/or an LI, among other examples.

As shown by reference number 1125, the UE 120 may transmit, and the network node 110 may receive, a CSI report. For example, the UE 120 may transmit the CSI report that includes CSI that is in accordance with at least one sub-configuration. For example, the network node 110 may indicate N sub-configuration (e.g., from L configured sub-configurations) for which the UE 120 is to calculate and/or report CSI. For example, the UE 120 may receive triggering information for reporting CSI. In some cases, the UE 120 may receive DCI that indicates for the UE 120 to aperiodically report CSI via a PUSCH. A list of trigger states may be configured in a CSI aperiodic trigger state list (CSI-AperiodicTriggerStateList), and each trigger state included in the list of trigger states may include a list of associated reporting settings. In some other cases, the UE 120 may receive DCI that indicates for the UE to semi-persistently report CSI via the PUSCH. A list of trigger states may be configured in a CSI semi-persistent state list (CSI-SemiPersistentOnPUSCH-TriggerStateList), and each trigger state included in the list of trigger states may include a list of associated reporting settings. In some other cases, the UE 120 may receive a MAC-CE that indicates for the UE to semi-persistently report CSI via a PUCCH. In some cases, for a CSI report configuration with L sub-configuration(s), the UE may be configured to report N CSI(s) in a single reporting instance, where the N CSI(s) are associated with N sub-configuration(s) from L (where 1≤N≤L) and each CSI corresponds to a single sub-configuration (e.g., the indication of the N CSI(s) may be indicated via DCI signaling or MAC-CE signaling).

In other words, the CSI report may indicate CSI that is calculated by the UE 120 using information indicated by a sub-configuration, such as a sub-configuration described in more detail elsewhere herein. The UE 120 may transmit the CSI report in a similar manner as described in more detail elsewhere herein. For example, the UE 120 may measure and report CSI according to all of the sub-configurations or according to a subset of the sub-configurations (e.g., associated with the CSI report configuration). For example, the network node 110 may provide an indication of which sub-configurations are to be reported (e.g., via the CSI report configuration). For example, the CSI report may indicate one or more single TRP CSI estimations (e.g., that are calculated using a single CMR configured via the sub-configuration) and/or one or more multi-TRP CSI estimations (e.g., that are calculated using a pair of CMRs configured via the sub-configuration).

As shown by reference number 1130, the network node 110 may configure spatial domain (SD) adaptation for one or more TRPs. For example, the network node 110 may configure the spatial domain adaptation for one or more TRPs based on the CSI report. The network node may transmit a PDSCH with a suitable configuration of spatial elements. For example, the network node 110 may switch among different configurations of active spatial elements or CSI-RS ports based on the CSI report (e.g., CSF) from the UE 120. In other words, the CSI report may indicate which configuration of active CSI-RS ports (for Type 1 spatial domain adaptation) or active antenna elements (for Type 2 spatial domain adaptation) is suitable for a communication link with the UE 120. This may enable the network node to deactivate or shut off one or more CSI-RS ports or antenna elements for the TRP A and/or the TRP B. As a result, this may reduce power consumption for a multi-TRP deployment by enabling the network node 110 to configure spatial domain adaptation for the TRP A and/or the TRP B.

As indicated above, FIG. 11 is provided as an example. Other examples may differ from what is described with respect to FIG. 11.

FIG. 12 is a diagram illustrating an example process 1200 performed, for example, at a UE or an apparatus of a UE, in accordance with the present disclosure. Example process 1200 is an example where the apparatus or the UE (e.g., UE 120) performs operations associated with CSI for spatial domain adaptation.

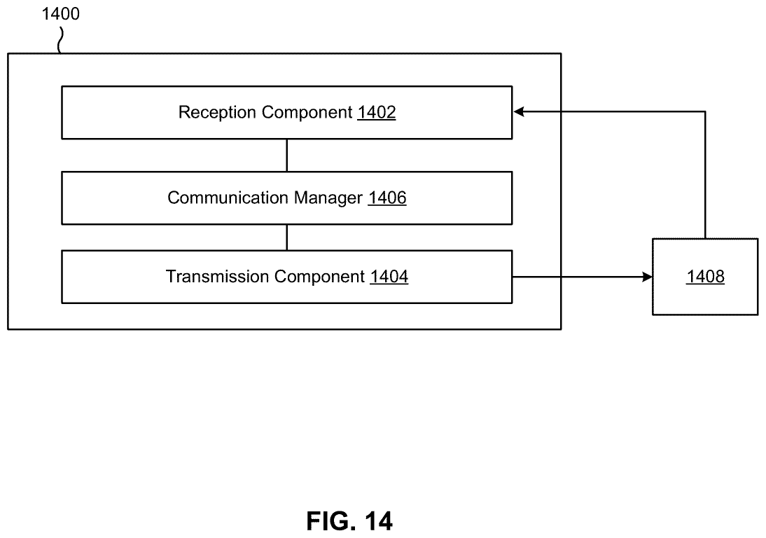

As shown in FIG. 12, in some aspects, process 1200 may include receiving a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group (block 1210). For example, the UE (e.g., using reception component 1402 and/or communication manager 1406, depicted in FIG. 14) may receive a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group, as described above. In some aspects, the CSI-RS resource set is associated with a first one or more CSI-RS resources included in a first resource group and a second one or more CSI-RS resources included in a second resource group. In some aspects, the CSI report configuration further indicates a sub-configuration indicating at least one of: first configuration information for the first resource group and second configuration information for the second resource group, or third configuration information associated with one or more pairs of resources from the first resource group and the second resource group.

As further shown in FIG. 12, in some aspects, process 1200 may include transmitting a CSI report that includes CSI that is in accordance with the sub-configuration (block 1220). For example, the UE (e.g., using transmission component 1404 and/or communication manager 1406, depicted in FIG. 14) may transmit a CSI report that includes CSI that is in accordance with the sub-configuration, as described above.

Process 1200 may include additional aspects, such as any single aspect or any combination of aspects described below and/or in connection with one or more other processes described elsewhere herein.

In a first aspect, the sub-configuration indicates fourth configuration information that is common for both the first resource group and the second resource group.

In a second aspect, alone or in combination with the first aspect, the fourth configuration information indicates at least one of a common CSI-RS port configuration, a common CSI-RS port subset indication, a common codebook subset restriction, or a common rank restriction for CSI computation using a single CSI-RS resource from the first resource group or the second resource group.

In a third aspect, alone or in combination with one or more of the first and second aspects, the first configuration information indicates a first codebook subset restriction and the second configuration information indicates a second codebook subset restriction.

In a fourth aspect, alone or in combination with one or more of the first through third aspects, the third configuration information indicates rank restrictions for respective pairs of resources of the one or more pairs of resources.

In a fifth aspect, alone or in combination with one or more of the first through fourth aspects, the first configuration information indicates a first CSI-RS port configuration and the second configuration information indicates a second CSI-RS port configuration.

In a sixth aspect, alone or in combination with one or more of the first through fifth aspects, the first configuration information indicates a first CSI-RS port subset indication and the second configuration information indicates a second CSI-RS port subset indication.

In a seventh aspect, alone or in combination with one or more of the first through sixth aspects, the first configuration information indicates a first rank restriction and the second configuration information indicates a second rank restriction.

In an eighth aspect, alone or in combination with one or more of the first through seventh aspects, a pair of resources, of the one or more pairs of resources, includes a first CSI-RS resource included in the first resource group and a second CSI-RS resource included in the second resource group, wherein the first configuration information indicates a first one or more parameters applicable to the first CSI-RS resource, and wherein the second configuration information indicates a second one or more parameters applicable to the second CSI-RS resource.

In a ninth aspect, alone or in combination with one or more of the first through eighth aspects, the CSI-RS resource set is associated with one or more CSI-RS resources for interference measurement, and the one or more CSI-RS resources for interference measurement are applicable to the sub-configuration.

In a tenth aspect, alone or in combination with one or more of the first through ninth aspects, the sub-configuration indicates a first one or more identifiers corresponding to the first one or more CSI-RS resources, and a second one or more identifiers corresponding to the second one or more CSI-RS resources.

In an eleventh aspect, alone or in combination with one or more of the first through tenth aspects, the sub-configuration indicates the one or more pairs of resources, wherein each pair of resources, of the one or more pairs of resources, includes two resources from different resource groups of the first resource group and the second resource group.

In a twelfth aspect, alone or in combination with one or more of the first through eleventh aspects, the third configuration information indicates a rank restriction associated with CSI computations using the one or more pairs of resources.

In a thirteenth aspect, alone or in combination with one or more of the first through twelfth aspects, the CSI report configuration indicates the first resource group and the second resource group, and the sub-configuration indicates a first one or more identifiers corresponding to at least one CSI-RS resource included in the first resource group, and a second one or more identifiers corresponding to at least one CSI-RS resource included in the second resource group.

In a fourteenth aspect, alone or in combination with one or more of the first through thirteenth aspects, the sub-configuration indicates the one or more pairs of resources, wherein each pair of resources, of the one or more pairs of resources, includes two resources from different resource groups from the at least one CSI-RS resource included in the first resource group and the at least one CSI-RS resource included in the second resource group.

In a fifteenth aspect, alone or in combination with one or more of the first through fourteenth aspects, the third configuration information indicates a rank restriction associated with CSI computations using the one or more pairs of resources.

In a sixteenth aspect, alone or in combination with one or more of the first through fifteenth aspects, the CSI-RS resource set indicates a first CSI-RS port configuration, and the sub-configuration is associated with a second one or more CSI-RS port configurations.

In a seventeenth aspect, alone or in combination with one or more of the first through sixteenth aspects, the CSI-RS resource set indicates CSI-RS port configuration that is applicable to the sub-configuration.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a network node or an apparatus of a network node, in accordance with the present disclosure. Example process 1300 is an example where the apparatus or the network node (e.g., network node 110) performs operations associated with CSI for spatial domain adaptation.

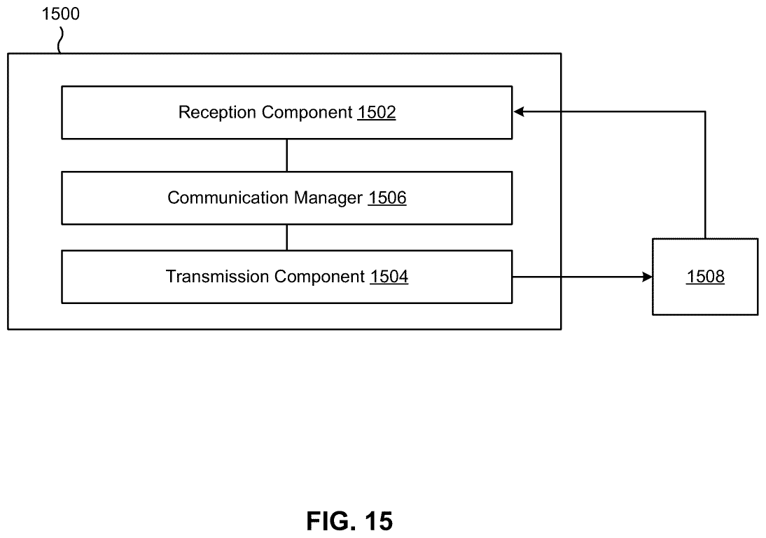

As shown in FIG. 13, in some aspects, process 1300 may include transmitting a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group (block 1310). For example, the network node (e.g., using transmission component 1504 and/or communication manager 1506, depicted in FIG. 15) may transmit a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group, as described above. In some aspects, the CSI-RS resource set is associated with a first one or more CSI-RS resources included in a first resource group and a second one or more CSI-RS resources included in a second resource group. In some aspects, the CSI report configuration further indicates a sub-configuration indicating at least one of: first configuration information for the first resource group and second configuration information for the second resource group, or third configuration information associated with one or more pairs of resources from the first resource group and the second resource group.

As further shown in FIG. 13, in some aspects, process 1300 may include receiving a CSI report that includes CSI that is in accordance with the sub-configuration (block 1320). For example, the network node (e.g., using reception component 1502 and/or communication manager 1506, depicted in FIG. 15) may receive a CSI report that includes CSI that is in accordance with the sub-configuration, as described above.

Process 1300 may include additional aspects, such as any single aspect or any combination of aspects described below and/or in connection with one or more other processes described elsewhere herein.

In a first aspect, the sub-configuration indicates fourth configuration information that is common for both the first resource group and the second resource group.

In a second aspect, alone or in combination with the first aspect, the fourth configuration information indicates at least one of a common CSI-RS port configuration, a common CSI-RS port subset indication, a common codebook subset restriction, or a common rank restriction for CSI computation using a single CSI-RS resource from the first resource group or the second resource group.

In a third aspect, alone or in combination with one or more of the first and second aspects, the first configuration information indicates a first codebook subset restriction and the second configuration information indicates a second codebook subset restriction.

In a fourth aspect, alone or in combination with one or more of the first through third aspects, the third configuration information indicates rank restrictions for respective pairs of resources of the one or more pairs of resources.

In a fifth aspect, alone or in combination with one or more of the first through fourth aspects, the first configuration information indicates a first CSI-RS port configuration and the second configuration information indicates a second CSI-RS port configuration.

In a sixth aspect, alone or in combination with one or more of the first through fifth aspects, the first configuration information indicates a first CSI-RS port subset indication and the second configuration information indicates a second CSI-RS port subset indication.

In a seventh aspect, alone or in combination with one or more of the first through sixth aspects, the first configuration information indicates a first rank restriction and the second configuration information indicates a second rank restriction.

In an eighth aspect, alone or in combination with one or more of the first through seventh aspects, a pair of resources, of the one or more pairs of resources, includes a first CSI-RS resource included in the first resource group and a second CSI-RS resource included in the second resource group, wherein the first configuration information indicates a first one or more parameters applicable to the first CSI-RS resource, and wherein the second configuration information indicates a second one or more parameters applicable to the second CSI-RS resource.

In a ninth aspect, alone or in combination with one or more of the first through eighth aspects, the CSI-RS resource set is associated with one or more CSI-RS resources for interference measurement, and the one or more CSI-RS resources for interference measurement are applicable to the sub-configuration.

In a tenth aspect, alone or in combination with one or more of the first through ninth aspects, the sub-configuration indicates a first one or more identifiers corresponding to the first one or more CSI-RS resources, and a second one or more identifiers corresponding to the second one or more CSI-RS resources.

In an eleventh aspect, alone or in combination with one or more of the first through tenth aspects, the sub-configuration indicates the one or more pairs of resources, wherein each pair of resources, of the one or more pairs of resources, includes two resources from different resource groups of the first resource group and the second resource group.

In a twelfth aspect, alone or in combination with one or more of the first through eleventh aspects, the third configuration information indicates a rank restriction associated with CSI computations using the one or more pairs of resources.

In a thirteenth aspect, alone or in combination with one or more of the first through twelfth aspects, the CSI report configuration indicates the first resource group and the second resource group, and the sub-configuration indicates a first one or more identifiers corresponding to at least one CSI-RS resource included in the first resource group, and a second one or more identifiers corresponding to at least one CSI-RS resource included in the second resource group.

In a fourteenth aspect, alone or in combination with one or more of the first through thirteenth aspects, the sub-configuration indicates the one or more pairs of resources, wherein each pair of resources, of the one or more pairs of resources, includes two resources from different resource groups from the at least one CSI-RS resource included in the first resource group and the at least one CSI-RS resource included in the second resource group.

In a fifteenth aspect, alone or in combination with one or more of the first through fourteenth aspects, the third configuration information indicates a rank restriction associated with CSI computations using the one or more pairs of resources.

In a sixteenth aspect, alone or in combination with one or more of the first through fifteenth aspects, the CSI-RS resource set indicates a first CSI-RS port configuration, and the sub-configuration is associated with a second one or more CSI-RS port configurations.

In a seventeenth aspect, alone or in combination with one or more of the first through sixteenth aspects, the CSI-RS resource set indicates CSI-RS port configuration that is applicable to the sub-configuration.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIG. 11. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group. The transmission component 1404 may transmit a CSI report that includes CSI that is in accordance with the sub-configuration.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIG. 11. Additionally, or alternatively, the apparatus 1500 may be configured to perform one or more processes described herein, such as process 1300 of FIG. 13, or a combination thereof. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1504 may be co-located with the reception component 1502 in one or more transceivers.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may transmit a CSI report configuration that indicates a CSI-RS resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group. The reception component 1502 may receive a CSI report that includes CSI that is in accordance with the sub-configuration.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving a channel state information (CSI) report configuration that indicates a CSI reference signal (CSI-RS) resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group; and transmitting a CSI report that includes CSI that is in accordance with the sub-configuration.

Aspect 2: The method of Aspect 1, wherein the sub-configuration indicates fourth configuration information that is common for both the first resource group and the second resource group.

Aspect 3: The method of Aspect 2, wherein the fourth configuration information indicates at least one of: a common CSI-RS port configuration, a common CSI-RS port subset indication, a common codebook subset restriction, or a common rank restriction for CSI computation using a single CSI-RS resource from the first resource group or the second resource group.

Aspect 4: The method of any of Aspects 1-3, wherein the first configuration information indicates a first codebook subset restriction and the second configuration information indicates a second codebook subset restriction.

Aspect 5: The method of any of Aspects 1-4, wherein the third configuration information indicates rank restrictions for respective pairs of resources of the one or more pairs of resources.

Aspect 6: The method of any of Aspects 1-5, wherein the first configuration information indicates a first CSI-RS port configuration and the second configuration information indicates a second CSI-RS port configuration.

Aspect 7: The method of any of Aspects 1-6, wherein the first configuration information indicates a first CSI-RS port subset indication and the second configuration information indicates a second CSI-RS port subset indication.

Aspect 8: The method of any of Aspects 1-7, wherein the first configuration information indicates a first rank restriction and the second configuration information indicates a second rank restriction.

Aspect 9: The method of any of Aspects 1-8, wherein a pair of resources, of the one or more pairs of resources, includes a first CSI-RS resource included in the first resource group and a second CSI-RS resource included in the second resource group, wherein the first configuration information indicates a first one or more parameters applicable to the first CSI-RS resource, and wherein the second configuration information indicates a second one or more parameters applicable to the second CSI-RS resource.

Aspect 10: The method of any of Aspects 1-9, wherein the CSI-RS resource set is associated with one or more CSI-RS resources for interference measurement, and wherein the one or more CSI-RS resources for interference measurement are applicable to the sub-configuration.

Aspect 11: The method of any of Aspects 1-10, wherein the sub-configuration indicates: a first one or more identifiers corresponding to the first one or more CSI-RS resources, and a second one or more identifiers corresponding to the second one or more CSI-RS resources.

Aspect 12: The method of Aspect 11, wherein the sub-configuration indicates the one or more pairs of resources, wherein each pair of resources, of the one or more pairs of resources, includes two resources from different resource groups of the first resource group and the second resource group.

Aspect 13: The method of Aspect 12, wherein the third configuration information indicates a rank restriction associated with CSI computations using the one or more pairs of resources.

Aspect 14: The method of any of Aspects 1-13, wherein the CSI report configuration indicates the first resource group and the second resource group, and wherein the sub-configuration indicates: a first one or more identifiers corresponding to at least one CSI-RS resource included in the first resource group, and a second one or more identifiers corresponding to at least one CSI-RS resource included in the second resource group.

Aspect 15: The method of Aspect 14, wherein the sub-configuration indicates the one or more pairs of resources, wherein each pair of resources, of the one or more pairs of resources, includes two resources from different resource groups from the at least one CSI-RS resource included in the first resource group and the at least one CSI-RS resource included in the second resource group.

Aspect 16: The method of Aspect 15, wherein the third configuration information indicates a rank restriction associated with CSI computations using the one or more pairs of resources.

Aspect 17: The method of any of Aspects 1-16, wherein the CSI-RS resource set indicates a first CSI-RS port configuration, and wherein the sub-configuration is associated with a second one or more CSI-RS port configurations.

Aspect 18: The method of any of Aspects 1-17, wherein the CSI-RS resource set indicates CSI-RS port configuration that is applicable to the sub-configuration.

Aspect 19: The method of any of Aspects 1-18, wherein the first resource group is associated with a first transmission reception point (TRP) and the second resource group is associated with a second TRP.

Aspect 20: A method of wireless communication performed by a network node, comprising: transmitting a channel state information (CSI) report configuration that indicates a CSI reference signal (CSI-RS) resource set for channel measurement, wherein the CSI-RS resource set is associated with a first one or more CSI-RS resources included in a first resource group and a second one or more CSI-RS resources included in a second resource group, and wherein the CSI report configuration further indicates a sub-configuration indicating at least one of: first configuration information for the first resource group and second configuration information for the second resource group, or third configuration information associated with one or more pairs of resources from the first resource group and the second resource group; and receiving a CSI report that includes CSI that is in accordance with the sub-configuration.

Aspect 21: The method of Aspect 20, wherein the sub-configuration indicates fourth configuration information that is common for both the first resource group and the second resource group.

Aspect 22: The method of Aspect 21, wherein the fourth configuration information indicates at least one of: a common CSI-RS port configuration, a common CSI-RS port subset indication, a common codebook subset restriction, or a common rank restriction for CSI computation using a single CSI-RS resource from the first resource group or the second resource group.

Aspect 23: The method of any of Aspects 20-22, wherein the first configuration information indicates a first codebook subset restriction and the second configuration information indicates a second codebook subset restriction.

Aspect 24: The method of any of Aspects 20-23, wherein the third configuration information indicates rank restrictions for respective pairs of resources of the one or more pairs of resources.

Aspect 25: The method of any of Aspects 20-24, wherein the first configuration information indicates a first CSI-RS port configuration and the second configuration information indicates a second CSI-RS port configuration.

Aspect 26: The method of any of Aspects 20-25, wherein the first configuration information indicates a first CSI-RS port subset indication and the second configuration information indicates a second CSI-RS port subset indication.

Aspect 27: The method of any of Aspects 20-26, wherein the first configuration information indicates a first rank restriction and the second configuration information indicates a second rank restriction.

Aspect 28: The method of any of Aspects 20-27, wherein a pair of resources, of the one or more pairs of resources, includes a first CSI-RS resource included in the first resource group and a second CSI-RS resource included in the second resource group, wherein the first configuration information indicates a first one or more parameters applicable to the first CSI-RS resource, and wherein the second configuration information indicates a second one or more parameters applicable to the second CSI-RS resource.

Aspect 29: The method of any of Aspects 20-28, wherein the CSI-RS resource set is associated with one or more CSI-RS resources for interference measurement, and wherein the one or more CSI-RS resources for interference measurement are applicable to the sub-configuration.

Aspect 30: The method of any of Aspects 20-29, wherein the sub-configuration indicates: a first one or more identifiers corresponding to the first one or more CSI-RS resources, and a second one or more identifiers corresponding to the second one or more CSI-RS resources.

Aspect 31: The method of Aspect 30, wherein the sub-configuration indicates the one or more pairs of resources, wherein each pair of resources, of the one or more pairs of resources, includes two resources from different resource groups of the first resource group and the second resource group.

Aspect 32: The method of Aspect 31, wherein the third configuration information indicates a rank restriction associated with CSI computations using the one or more pairs of resources.

Aspect 33: The method of any of Aspects 20-32, wherein the CSI report configuration indicates the first resource group and the second resource group, and wherein the sub-configuration indicates: a first one or more identifiers corresponding to at least one CSI-RS resource included in the first resource group, and a second one or more identifiers corresponding to at least one CSI-RS resource included in the second resource group.

Aspect 34: The method of Aspect 33, wherein the sub-configuration indicates the one or more pairs of resources, wherein each pair of resources, of the one or more pairs of resources, includes two resources from different resource groups from the at least one CSI-RS resource included in the first resource group and the at least one CSI-RS resource included in the second resource group.

Aspect 35: The method of Aspect 34, wherein the third configuration information indicates a rank restriction associated with CSI computations using the one or more pairs of resources.

Aspect 36: The method of any of Aspects 20-35, wherein the CSI-RS resource set indicates a first CSI-RS port configuration, and wherein the sub-configuration is associated with a second one or more CSI-RS port configurations.

Aspect 37: The method of any of Aspects 20-36, wherein the CSI-RS resource set indicates CSI-RS port configuration that is applicable to the sub-configuration.

Aspect 38: The method of any of Aspects 20-37, wherein the first resource group is associated with a first transmission reception point (TRP) and the second resource group is associated with a second TRP.

Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-38.

Aspect 40: An apparatus for wireless communication at a device, the apparatus comprising one or more memories and one or more processors coupled to the one or more memories, the one or more processors configured to cause the device to perform the method of one or more of Aspects 1-38.

Aspect 41: An apparatus for wireless communication, the apparatus comprising at least one means for performing the method of one or more of Aspects 1-38.

Aspect 42: A non-transitory computer-readable medium storing code for wireless communication, the code comprising instructions executable by one or more processors to perform the method of one or more of Aspects 1-38.

Aspect 43: A non-transitory computer-readable medium storing a set of instructions for wireless communication, the set of instructions comprising one or more instructions that, when executed by one or more processors of a device, cause the device to perform the method of one or more of Aspects 1-38.

Aspect 44: A device for wireless communication, the device comprising a processing system that includes one or more processors and one or more memories coupled with the one or more processors, the processing system configured to cause the device to perform the method of one or more of Aspects 1-38.

Aspect 45: An apparatus for wireless communication at a device, the apparatus comprising one or more memories and one or more processors coupled to the one or more memories, the one or more processors individually or collectively configured to cause the device to perform the method of one or more of Aspects 1-38.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication, comprising:
one or more memories; and
one or more processors coupled to the one or more memories, the one or more processors individually or collectively configured to:
receive a channel state information (CSI) report configuration that indicates a CSI reference signal (CSI-RS) resource set for channel measurement,
wherein the CSI-RS resource set is associated with a first one or more CSI-RS resources included in a first resource group and a second one or more CSI-RS resources included in a second resource group, and
wherein the CSI report configuration further indicates a sub-configuration indicating at least one of:
first configuration information for the first resource group and second configuration information for the second resource group, or
third configuration information associated with one or more pairs of resources from the first resource group and the second resource group; and
transmit a CSI report that includes CSI that is in accordance with the sub-configuration.

2. The apparatus of claim 1, wherein the sub-configuration indicates fourth configuration information that is common for both the first resource group and the second resource group.

3. The apparatus of claim 2, wherein the fourth configuration information indicates at least one of:
a common CSI-RS port configuration,
a common CSI-RS port subset indication,
a common codebook subset restriction, or
a common rank restriction for CSI computation using a single CSI-RS resource from the first resource group or the second resource group.

4. The apparatus of claim 1, wherein the first configuration information indicates a first codebook subset restriction and the second configuration information indicates a second codebook subset restriction.

5. The apparatus of claim 1, wherein the third configuration information indicates rank restrictions for respective pairs of resources of the one or more pairs of resources.

6. The apparatus of claim 1, wherein the first configuration information indicates a first CSI-RS port configuration and the second configuration information indicates a second CSI-RS port configuration.

7. The apparatus of claim 1, wherein the first configuration information indicates a first CSI-RS port subset indication and the second configuration information indicates a second CSI-RS port subset indication.

8. The apparatus of claim 1, wherein the first configuration information indicates a first rank restriction and the second configuration information indicates a second rank restriction.

9. The apparatus of claim 1, wherein a pair of resources, of the one or more pairs of resources, includes a first CSI-RS resource included in the first resource group and a second CSI-RS resource included in the second resource group,
wherein the first configuration information indicates a first one or more parameters applicable to the first CSI-RS resource, and
wherein the second configuration information indicates a second one or more parameters applicable to the second CSI-RS resource.

10. The apparatus of claim 1, wherein the CSI-RS resource set is associated with one or more CSI-RS resources for interference measurement, and wherein the one or more CSI-RS resources for interference measurement are applicable to the sub-configuration.

11. An apparatus for wireless communication, comprising:
one or more memories; and
one or more processors coupled to the one or more memories, the one or more processors individually or collectively configured to:
transmit a channel state information (CSI) report configuration that indicates a CSI reference signal (CSI-RS) resource set for channel measurement,
wherein the CSI-RS resource set is associated with a first one or more CSI-RS resources included in a first resource group and a second one or more CSI-RS resources included in a second resource group, and
wherein the CSI report configuration further indicates a sub-configuration indicating at least one of:
first configuration information for the first resource group and second configuration information for the second resource group, or
third configuration information associated with one or more pairs of resources from the first resource group and the second resource group; and
receive a CSI report that includes CSI that is in accordance with the sub-configuration.

12. The apparatus of claim 11, wherein the sub-configuration indicates fourth configuration information that is common for both the first resource group and the second resource group.

13. The apparatus of claim 12, wherein the fourth configuration information indicates at least one of:
a common CSI-RS port configuration,
a common CSI-RS port subset indication,
a common codebook subset restriction, or
a common rank restriction for CSI computation using a single CSI-RS resource from the first resource group or the second resource group.

14. The apparatus of claim 11, wherein the first configuration information indicates a first codebook subset restriction and the second configuration information indicates a second codebook subset restriction.

15. The apparatus of claim 11, wherein the third configuration information indicates rank restrictions for respective pairs of resources of the one or more pairs of resources.

16. The apparatus of claim 11, wherein the first configuration information indicates a first CSI-RS port configuration and the second configuration information indicates a second CSI-RS port configuration.

17. The apparatus of claim 11, wherein the first configuration information indicates a first CSI-RS port subset indication and the second configuration information indicates a second CSI-RS port subset indication.

18. A method of wireless communication performed by a user equipment (UE), comprising:
receiving a channel state information (CSI) report configuration that indicates a CSI reference signal (CSI-RS) resource set for channel measurement,
wherein the CSI-RS resource set is associated with a first one or more CSI-RS resources included in a first resource group and a second one or more CSI-RS resources included in a second resource group, and
wherein the CSI report configuration further indicates a sub-configuration indicating at least one of:
first configuration information for the first resource group and second configuration information for the second resource group, or
third configuration information associated with one or more pairs of resources from the first resource group and the second resource group; and
transmitting a CSI report that includes CSI that is in accordance with the sub-configuration.

19. The method of claim 18, wherein the first resource group is associated with a first transmission reception point (TRP) and the second resource group is associated with a second TRP.

20. The method of claim 18, wherein the sub-configuration indicates:
a first one or more identifiers corresponding to the first one or more CSI-RS resources, and
a second one or more identifiers corresponding to the second one or more CSI-RS resources.

21. The method of claim 20, wherein the sub-configuration indicates the one or more pairs of resources,
wherein each pair of resources, of the one or more pairs of resources, includes two resources from different resource groups of the first resource group and the second resource group.

22. The method of claim 21, wherein the third configuration information indicates a rank restriction associated with CSI computations using the one or more pairs of resources.

23. The method of claim 18, wherein the CSI report configuration indicates the first resource group and the second resource group, and
wherein the sub-configuration indicates:
a first one or more identifiers corresponding to at least one CSI-RS resource included in the first resource group, and
a second one or more identifiers corresponding to at least one CSI-RS resource included in the second resource group.

24. The method of claim 23, wherein the sub-configuration indicates the one or more pairs of resources,
wherein each pair of resources, of the one or more pairs of resources, includes two resources from different resource groups from the at least one CSI-RS resource included in the first resource group and the at least one CSI-RS resource included in the second resource group.

25. The method of claim 24, wherein the third configuration information indicates a rank restriction associated with CSI computations using the one or more pairs of resources.

26. The method of claim 18, wherein the CSI-RS resource set indicates a first CSI-RS port configuration, and
wherein the sub-configuration is associated with a second one or more CSI-RS port configurations.

27. The method of claim 18, wherein the CSI-RS resource set indicates CSI-RS port configuration that is applicable to the sub-configuration.

28. A method of wireless communication performed by a network node, comprising:
transmitting a channel state information (CSI) report configuration that indicates a CSI reference signal (CSI-RS) resource set for channel measurement,
wherein the CSI-RS resource set is associated with a first one or more CSI-RS resources included in a first resource group and a second one or more CSI-RS resources included in a second resource group, and
wherein the CSI report configuration further indicates a sub-configuration indicating at least one of:
first configuration information for the first resource group and second configuration information for the second resource group, or
third configuration information associated with one or more pairs of resources from the first resource group and the second resource group; and
receiving a CSI report that includes CSI that is in accordance with the sub-configuration.

29. The method of claim 28, wherein the sub-configuration indicates fourth configuration information that is common for both the first resource group and the second resource group.

30. The method of claim 28, wherein the first configuration information indicates a first CSI-RS port configuration and the second configuration information indicates a second CSI-RS port configuration.
